(19) United States
(12) Patent Application Publication
(10) Pub. No.: US 2010/0294805 A1
(43) Pub. Date: Nov. 25, 2010

(54) DISPENSER FOR DISPENSING LIQUID OR PASTY MATERIALS

(76) Inventors: Guentor Pohlmann, Lohne (DE); Franz Weingarten, Berghelm (DE); Martin Presche, Dinklage (DE)

Correspondence Address: COLLARD & ROE, P.C., 1077 NORTHERN BOULEVARD, ROSLYN, NY, 11576, US

(21) Appl. No.: 12/452,191

(22) PCT Filed: Jun. 30, 2008
(86) PCT No.: PCT/EP2008/058357

§ 371 Date: Apr. 14, 2010

(30) Foreign Application Priority Data
Jun. 29, 2007 (DE) 10 2007 030 351.5
Jun. 20, 2008 (DE) 10 2008 029 004.1

(51) Int. Cl. B67D 7/06; B67D 7/60

(52) U.S. Cl. 222/153.14; 222/383.1

(57) ABSTRACT

The invention relates to a dispenser (1) for dispensing liquid or pasty materials (M), with a reservoir (2) for the materials, a head piece (3), a pump chamber (27), and an outlet valve (A) and inlet valve (E), wherein the pump chamber (27) is formed as a uniform pump chamber body (5) made of a resilient plastic, and the pump chamber body (5) has a floor attachment section (29) designed as an annular collar. To ensure that a dispenser of the type in question can be easily assembled while having the simplest possible structure, it is first proposed that the outlet valve (A) and/or the inlet valve (E) is composed of a flat part (44) which is separate from but cooperates with the pump chamber body (5) and which, with at any rate partial vertical mobility, bears on the pump chamber body (5). A further aspect of a dispenser of the type in question is that an impression part (22) is provided which is vertically assigned to the floor attachment section (29) and which can be acted on via the head piece (3). In a further aspect of a dispenser of the type in question, provision is made that the inlet valve (E) is composed of a flat body (48) which is connected to the pump chamber body (5) and which bears on a chamber closure part (9) on the reservoir side.

The invention relates to a dispenser for dispensing liquid or pasty substances, with a substance reservoir, a head piece, a pumping chamber, and an outlet valve and an inlet valve, the pumping chamber being formed from a spring-elastic plastics material as a one-part pumping chamber body and the pumping chamber body having a base securing portion formed as an annular collar.

Dispensers of the type in question are known and serve for the portioned dispensing of substances, the pumping chamber filled with substance being at least partially emptied in the course of a pumping operation to dispense the substance and being filled again with substance from the reservoir in the course of a return movement of the head piece initiating the pumping operation. The passing of the substance through the pumping chamber is controlled by way of an outlet valve and an inlet valve.

With regard to the prior art described above, a technical problem for the invention is seen as that of configuring a dispenser of the type in question in a way that is advantageous for assembly, with a construction that is as simple as possible.

This problem is solved first and foremost by the subject matter of claim 1, it being provided that the outlet valve and/or the inlet valve comprises a flat part which is separate from but interacts with the pumping chamber body and rests on the pumping chamber body with at least partial freedom of vertical movement. This provides a valve which can be positioned in a manner that is advantageous for assembly. The flat part provides sealing over a surface area in the region where the flat part and the pumping chamber body interact. Depending on the pressure conditions in the pumping chamber body, opening of the valve configured in this way can be achieved by at least partial vertical displacement of the flat part to release a passage for the medium between the flat part and the pumping chamber body. The flat part preferably consists of a soft spring elastic plastics material, such as for example a thermoplastic elastomer.

The invention also relates to a dispenser according to the features of the preamble of claim 1 or according to claim 1, in which a configuration that is advantageous for assembly is achieved by providing a pressing-in formation that is vertically associated with the base securing portion and can be acted upon by way of the head piece. This pressing-in formation is used to make the base securing portion of the pumping chamber move into the desired engaging position, so that in the course of an initial actuation of the dispenser with accompanying displacement of the head piece by way of the pressing-in formation, the pumping chamber or the base securing portion thereof can be urged into the defined engaging position if this has not already been achieved during the assembly of the pumping chamber. To make it match the base securing portion, the pressing-in formation is preferably also in the form of a circular ring in cross-section, so that more preferably the base securing portion is acted upon over the entire circumference of the annular collar. It is additionally possible for the annular collar to be acted upon only partially. In this respect it also proves to be advantageous if, in the course of each pumping operation, the pressing-in formation acts upon the annular collar of the base securing portion, in order that in this way engagement is always secured. This makes it possible to dispense with additional means for securing the pumping chamber body to the associated housing portion, for example by adhesive bonding or welding. For example, frictional engagement of the pumping chamber body on the housing portion is sufficient.

The invention also relates to a dispenser according to the features of the preamble of claim 1 or according to either or both of claims 1 and 2, in which a configuration that is advantageous for assembly and of a simple construction is achieved by the inlet valve comprising a flat body which is connected to the pumping chamber body and rests on a chamber closure part on the reservoir side. The flat body is in this case preferably formed as one part with the pumping chamber body, more preferably from the same material, preferably has correspondingly spring-elastic properties on account of the plastics material chosen. The sealing seat for the flat body is formed directly by the chamber closure part closing the reservoir toward the head piece. The one-piece configuration of the flat body and the pumping chamber body makes assembly easy, in particular with regard to the configuration of the inlet valve. There is no unattached piece forming the inlet valve. Insertion of the pumping chamber body at the same time creates the inlet valve.

Further features of the invention are explained below, including in the description of the figures, frequently in their preferred association with the subject matter of claim 1 and/or the further independent claim 2 and/or the further independent claim 3 or features of further claims. They may, however, also be of importance in association with only individual features of claim 1 and/or of the further independent claim 2 and/or of the further independent claim 3 or of the respective further claim or in each case individually.

It is thus provided in a development of the subject matter of the invention that the outlet valve is formed as a collar of a cross-sectionally hat-like valve body, thus more particularly, with the hat-like valve body as a whole inverted in the position for use, the outlet valve thereof, in the form of a flat part, protruding radially in the manner of the brim of a hat. In particular, this collar forming the outlet valve is preferably made thinner radially outwardly in the manner of a lip, in order in this way to offer sufficient freedom of movement for the opening and closing of the valve, this furthermore with elastic deformation. The valve collar is biased into the closure position while resting on the pump body. This biasing is preferably provided by the elastic properties of the valve collar alone. In a preferred configuration, the valve body forming the outlet valve is formed from polyethylene or a thermoplastic elastomer.

With the head piece of the dispenser configured as a plastics injection-molded part, for example by the two-component injection-molding process, the outlet valve may be formed on the head piece. A configuration in which the head piece has an inwardly protruding locking formation, for the locking retention of the outlet valve, in particular the valve body forming the outlet valve, is preferred. To this extent, advantageous assembly can be achieved. The latching retention is further chosen here in such a way that it withstands the pressure occurring in the pumping chamber in the course of the actuation of the dispenser, in particular the negative pressure occurring during return of the head piece. Adhesive bonding or welding of the outlet valve or valve body and the head piece are also possible.

In a further configuration of the subject matter of the invention, the vertical extent of the outlet valve or of the valve body forming the outlet valve corresponds to the radius, in particular the outer radius, of the outlet valve or exceeds it, thus furthermore corresponds for example to 1 to 2 times, furthermore corresponds for example to 1.1 to 1.5 times thereof. In addition, the degree of vertical extent of the outlet valve or valve body is adapted to the pumping displacement of the head piece; more preferably, it corresponds approximately to the extent of the displacement of the head piece.

In an advantageous configuration, it is provided that the inlet valve is a flat part that is attached to an inner wall of the pumping chamber body by way of resilient webs. This flat part is preferably formed in one piece with the pumping chamber body, from the same material; in a preferred configuration furthermore, like the pumping chamber body, it consists of a thermoplastic elastomer or polyethylene. Elastic properties are accordingly obtained in particular for the flat part forming the inlet valve, freedom of vertical movement of the inlet valve being provided by it being attached by way of the resilient webs. The latter may be aligned strictly radially in relation to the flat part, for the attachment of the same to the inner wall of the pumping chamber. In a preferred configuration, when considered in plan view of the flat part, the resilient webs extend in the manner of segments of a ring, attached at the end in each case to the pumping chamber wall and to the flat part, sufficient freedom of vertical movement of the flat part for the displacement of the same into the inlet-valve opening position being obtained as a result of this configuration.

The flat part is more preferably shaped in cross-section in the manner of a plug, for interacting with a correspondingly formed sealing seat. The plug-like configuration achieves reliable sealing of the inlet valve, in particular in the course of a discharge of substance brought about by actuation of the dispenser. The pressure thereby acting on the flat part in the course of the actuation of the dispenser has an advantageous effect on the inlet-valve closure position as a result of the plug-like configuration of the flat part. It proves to be advantageous in this connection if the flat part interacts with a passage opening formed in the chamber closure part, which chamber closure part covers over the space in the dispenser acting as a reservoir for the substance to be dispensed. In a preferred configuration, the flat part is shaped in cross-section in the form of a cone, more preferably tapering conically toward the sealing seat, which sealing seat is adapted in shape, furthermore correspondingly being likewise conically formed. As a further alternative, the flat part is shaped in cross-section in the form of a spherical cap, similar in form to a hollowed hemisphere, furthermore optionally with a mounting portion in the manner of a flat part, on which the spherical cap is formed. This proves to be advantageous to the extent that, even when the flat part forming the inlet valve is misaligned off-center in relation to the sealing seat, valve closure continues to be ensured.

In a further preferred configuration, the inlet valve is disposed offset with respect to the placement plane of the base securing portion, more preferably vertically offset in the direction of the dispenser head, so that accordingly the base securing portion completely encloses the region of the inlet valve. Thus, the inlet valve may furthermore be disposed approximately halfway up the base securing portion.

In a further preferred configuration, the pumping chamber body is shaped in the manner of bellows, it being further preferred in this connection that the base securing portion of the pumping chamber body narrows in diameter above the attachment of the inlet valve, thus furthermore in particular in relation to the inner diameter of the base securing portion. Thus, in a preferred configuration of the subject matter according to the invention, the narrowed inner diameter corresponds to 0.5 to 0.95 times, furthermore, for example, 0.75 to 0.85 times, the non-reduced inner diameter in the region of the placement plane of the base securing portion. It proves to be advantageous in this respect that the diametrically reduced inner diameter of the base securing portion above the attachment of the inlet valve is made greater than the greatest diameter of the passage opening to be closed by the inlet valve.

Following the attachment of the inlet valve, more preferably following the diametric narrowing of the base securing portion, the pumping chamber wall widens conically, thus in particular in the relaxed position of the pumping chamber wall which corresponds to the non-actuated position of the dispenser. This widening region of the pumping chamber wall runs horizontally, or virtually horizontally, in the pressed-down state, that is to say when the dispenser head piece is actuated.

The invention further provides that, in the pressed-down state of the pumping chamber wall, a folding of the same builds up above the widening region and in vertical projection on the widening region. The folding of the pumping chamber wall above the widening region also occurs in the unloaded state of the pumping chamber wall, although in this position the folding does not necessarily form in vertical projection on the widening region. Rather, in the relaxed position of the pumping chamber wall, the folding is provided such that it progressively increases radially with respect to the widening region.

In a further preferred configuration, the head piece that can be displaced vertically for actuation of the dispenser is guided on the chamber closure part, for which purpose the latter has, for example, a double-walled circumferential guide for the foot region of the head piece. Between the walls of the chamber closure part there is accordingly an annular space, in which the head piece engages in a vertically displaceable manner. A solution that is particularly advantageous in terms of assembly is achieved by an inner guidance for the head piece being provided merely by ribs aligned radially on the chamber closure part. Accordingly, no radially inner circumferential wall is provided. Rather, the inner support is provided by a plurality of ribs which are disposed in uniform distribution over the circumference and the vertical extent of which is adapted to the displacement path of the head piece.

In connection with a valve disk, it also proves to be of advantage if the valve seat is conically formed. The apex of the cone is associated here with the opening in the valve disk in such a way that, in the valve closure position, the rim of the opening in the valve disk acts in a sealing manner against the peripheral, descending flank of the conical valve seat. Alternatively, the valve seat of the valve disk may also be formed as a spherical cap, thus furthermore, for example, in the form of a hollowed hemisphere, the zenith of which is substantially associated with the opening in the valve disk. In the valve closure position, the rim of the opening in the valve disk acts in a sealing manner against the lateral surface of the spherical cap. As a result of the proposed configuration of the valve seat, an off-center misalignment with regard to the association between the valve disk and the valve seat does not cause any leakage. Rather, the valve closure position is maintained even when there is a corresponding misalignment of the valve disk from the central position in relation to the axis of alignment, for example in a slightly tilted position.

In a development of the subject matter of the invention it is provided that the pressing-in formation interacts with the transitional region between the inlet valve and the pumping chamber wall. Accordingly, in the immediate vicinity of the region where the substance enters the pumping chamber, the pressing-in formation engages on the base securing portion. For this purpose, the latter may also have an area of action that is adapted in cross-section to the operative end of the pressing-in formation and from which more preferably the pumping chamber wall protrudes radially outward. In a further preferred configuration, in the position in which it is acting, the acting free end of the pressing-in formation is at a distance from the area of contact of the base securing portion on the housing that corresponds to the material thickness of the base securing portion when considered in the vertical direction.

A configuration that is advantageous in terms of production is one in which the pressing-in formation is formed from the same material as the head piece, thus more preferably produced as a molded part by the injection-molding process. Polyethylene is used, for example, as the plastics material, while the pumping chamber consists of a soft spring-elastic plastics material, for example of a thermoplastic elastomer.

When considered over an axial length, a portion of the pumping chamber body has a changing wall thickness, the axial length of the pumping chamber body also corresponding to a multiple of its wall thickness. Thus, when the pumping chamber body as a whole is in a fold-free configuration in the relaxed state, the pumping chamber wall has a defined wall-thickness minimizing zone, in which a defined deformation of the wall is achieved when the pumping chamber wall is acted upon during the lowering of the head piece for the purpose of dispensing the substance. When considered over the axial length, the wall thickness changes in the range of tenths of a millimeter, thus furthermore in the range from 5 to 70% of the greatest wall thickness. Thus, furthermore, solely in the region of the pumping chamber wall surrounding the pumping chamber that can be filled with substance, a difference in wall thickness of, for example, 0.1 mm to 0.4 mm is provided, this with a maximum wall thickness of 0.9 mm to 1.5 mm. It is further preferred in this respect that the pumping chamber body has a smaller wall thickness in a middle region than in at least one of the end regions, which further assists the deliberate deformation of the pumping chamber wall in the course of the pumping operation. It proves to be of advantage in this respect if an end region of the pumping chamber wall that is at the foot and is associated with the base securing portion, and thus also furthermore with the inlet valve, has a wall thickness that is increased in comparison with the middle portion.

It is also provided that the pumping chamber body has an axial length which corresponds to 0.9 to 2 times the width, measured transversely thereto, of the pumping chamber body. The axial length and the width, measured transversely thereto, of the pumping chamber body relate only to the region accommodating the substance.

In a further preferred configuration, the pumping chamber has an inner contour which has a continuously widening portion and a continuously narrowing portion, the portions converging and diverging in the course of a pumping operation.

In a development of the subject matter of the invention, it is provided that the inlet valve comprises a valve disk with a central opening. In a preferred configuration, this valve disk is a flat body connected to the pumping chamber body by being made of the same material. The valve disk is more preferably attached here in such a way that it runs around the radially outer circumference of the pumping chamber body, while forming a central opening for liquid or pasty substance to pass through in the open position of the valve.

In a development, it is provided that the chamber closure part is closed where it is associated with the central opening in the valve disk, but radially outside this has a passage opening. This passage opening may, for example, be slit-shaped around the circumference. Alternatively, a number of such passage openings may also be provided, disposed radially outside the central opening in the valve disk. In the case of a conical configuration of the valve seat, in a further preferred configuration, the passage opening is disposed radially outside the valve disk opening in the region of the cone flank, covered over by the closed region of the valve disk at least in the closed position of the valve.

In particular in the case of a dispenser for dispensing liquid substances, it is provided that the chamber closure part continues on the reservoir side into a suction tube. This preferably extends from the inlet valve region to the base of the reservoir, while ending at a spacing from it.

It is also provided that the inlet valve comprises a valve disk with a central opening. In a preferred configuration, this valve disk is a closure body in the form of a circular ring that is attached to the pumping chamber body in one piece and made of the same material.

It is thus provided in a development of the subject matter of the invention that the flat part lies on the inner side against a tube portion connected to the head piece. This tube portion provides centering of the flat part, furthermore optionally also support in the vertical direction or in the pressing-in direction of the pumping chamber body. In a further configuration, the tube portion is the pressing-in formation connected to the head piece.

Moreover, it is proposed that, where it is associated with the flat part, the pumping chamber body is spaced apart from the tube portion, at least in certain regions, preferably with a radial spacing. As a result of this configuration, in the valve closure position, the flat part forms channel portions which can be covered over and closed and can be released as a result of the pressure-dependent freedom of vertical movement of the flat-part seal.

In a further configuration, the tube portion passing through the flat part on the inner side has supporting formations, which rest on the flat part from above and press it against the sealing seat on the pumping chamber body. The supporting formations are preferably disposed here such that they are distributed over the circumference of the tube portion, more preferably uniformly distributed when considered in the circumferential direction. Space is left between the supporting formations for portions of the flat part to move away vertically, corresponding to an opening of the valve. Thus, in the over-engaging region, the supporting formations are radially smaller than the flat part. It is preferably provided furthermore in this respect that the radial extent of the supporting formations corresponds approximately to the radial spacing between the pumping chamber body and the tubular portion in the region of association with the flat part.

The tube portion is surrounded by an annular dispensing chamber, which in the valve open position of the outlet valve is in connection with the pumping chamber. The supporting formations of the tube portion protrude into this dispensing chamber. In order to reduce a residual volume occurring in the dispensing chamber, it is also proposed that the supporting formations be radially smaller than the flat part in an over-engaging region associated with the dispensing channel and radially the same or larger than the flat part in a circumferentially following over-engaging region. Accordingly, in the over-engaging region following the dispensing channel, the radially increased supporting formations prevent the flat part from being displaced in the sense of opening the valve. As a result of the radially smaller supporting formations, it is only in the region associated with the dispensing channel that the flat part portion is able to move away in the sense of opening the valve as a result of pressure being applied, in order in this way to fill merely the region of the dispensing chamber that is associated with the dispensing channel. The radially widened supporting formations accordingly form a circumferential boundary of the dispensing chamber associated with the dispensing channel. Thus, furthermore, the supporting formations are formed by vertically aligned ribs which protrude radially from the tube portion and, depending on the configuration, are either smaller than the flat part in radial extent or, for the circumferential bounding of the dispensing chamber, are at least partially radially the same or larger than the flat part.

For the circumferential bounding of the dispensing chamber, the supporting formations that are formed as radially the same as or larger than the flat part may in particular be formed by a separate insert part, which engages radially around the tube portion. This is more preferably held on the tube portion in such a way that it is secured against displacement. Thus, furthermore, the insert part is shaped, for example, in plan view in the form of a segment of a circular ring, furthermore, for example, with a circular ring opening that is facing the dispensing channel and in plan view encloses for instance an angle of 30° to 45°.

In a preferred configuration, the flat part is formed as a circular ring body, this with a circular ring opening of a diameter that preferably corresponds to the diameter of the tube portion or the pressing-in formation underneath the supporting formations. Accordingly, the tube portion passes centrally through the circular ring body, with the wall of the tubular portion being closed off in a sealing manner by the flat part.

On the upper side, the pumping chamber body forms a supporting surface for the flat part, thus furthermore correspondingly a sealing seat. In the direction of this supporting surface, the flat part is pressed by the supporting formations acting on it from above. This supporting surface may be formed such that it is equal to or greater in radial extent than the radial extent of the flat part. In addition, a level supporting plane directed transversely in relation to the dispenser axis is possible. Furthermore, a supporting surface which rises radially outwardly from a plane aligned transversely in relation to the dispenser axis is also possible. As a further alternative, the supporting surface may also be concavely or convexly shaped in cross-section. Preferred in this respect is a configuration in which the radial extent of the supporting surface is less than the radial extent of the flat part, this being achieved, for example, by a rib or the like which is associated with the underside of the flat part and which is formed in the region of the supporting surface and emerges from the supporting plane. In this respect, individual ribs may be disposed such that they are distributed over the circumference. A continuous rib that is in the form of a ring in plan view is also possible. Resting on this rib, the flat part is held under prestress. Furthermore, such a configuration has the effect of increasing the contact pressure in the sealing seat—here in particular against the rib—which correspondingly provides increased leak-tightness.

The flat part is disposed within an outer, vertically extending dispensing channel wall, which latter is preferably disposed concentrically in relation to the tube portion or in relation to the pressing-in formation.

In a development of the subject matter of the invention in which the inlet valve and/or the outlet valve is formed on the pumping chamber body from the same material, facing inward with respect to the pumping chamber wall, in the shape of a lip in the form of a circular ring, it proves to be of advantage that the lip is convexly shaped, as seen in the direction in which the substance passes through. As a result of this configuration, the valve lips lie against the associated seal-making portions, in the direction in which the substance passes through. This has the effect of achieving an improved opening and sealing behavior of the valves.

In the case of a dispenser of the type in question, in which the pumping chamber body is formed in an elliptical shape in longitudinal cross-section, with a thrust collar protruding outward therefrom, but rooted in the pumping chamber wall, it is further provided that the thrust collar follows on from the pumping chamber wall by way of a transitional wall forming an angle of 45° to 120° with a local tangent to the pumping chamber wall. Thus, furthermore, this transitional wall may enclose an angle of 75 to 90° with the tangent. This produces a transitional wall which is formed by a portion of a cone. Along the end of the cone of reduced diameter, the transitional wall is rooted in the pumping chamber wall, and made of the same material, while the end region of the cone that is widened in diameter carries the thrust collar. The thrust collar itself is more preferably formed as a tube portion, with a thrust-collar center axis which accommodates the center axis of the entire pumping chamber body. The transitional wall emerging from the pumping chamber wall is more preferably formed in such a way that, in a vertical projection, the thrust collar carried by it lies outside the pumping chamber wall. This applies at least to the radially outwardly facing wall of the thrust collar, but preferably furthermore also the radially inwardly facing wall. Moreover, the inner diameter of the thrust collar is chosen to be greater than the outer diameter of the opposite base securing portion. Thus, for example, a ratio of thrust collar diameter to base securing portion diameter of 1.2:1 to 2:1, more preferably approximately 1.7:1, is selected.

Furthermore, the transitional wall carrying the thrust collar is rooted on the pumping chamber wall, in which root region the outlet valve formed as a lip in the form of a circular ring is also at the same time formed on it. The annular lip of the outlet valve interacts in a sealing manner with a tube- or rod-shaped wall portion of the head piece, the sealing seat configured in this way more preferably being formed by the pressing-in formation.

The dispenser is suitable for dispensing different liquid or pasty substances, thus, for example, cosmetic products, hair and/or skin care and cleaning products, such as furthermore creams, shampoos, hair colorants, sunscreens or water/oil-based emulsions with, for example, UV filter pigments, and so on. In this respect, reference is made, for example, to products and compositions such as those published by way of example in the following documents: DE 10 2005 019 549 A1, DE 102 37 737 A1, DE 10 2004 047 282 A1, DE 699 17 277 T2, DE 698 18 034 T2, DE 601 15 652 T2, DE 10 2005 020 071 A1, DE 33 02 921, DE 697 00 946 T2, U.S. Pat. No. 5,855,878, U.S. Pat. No. 5,730,966 and U.S. Pat. No. 5,674,509.

Wherever it is not stated in any case in the examples given, the numerical ranges respectively specified also include all intermediate values, to be precise in particular in increments of 1/10 from the lower and/or upper limits, respectively restricted to the other limit. “And” means here that both limits are respectively shifted by one or more tenths towards the other limit, i.e. are restricted.

The invention is explained in more detail below with reference to the accompanying drawing, which merely represents a number of exemplary embodiments and in which:

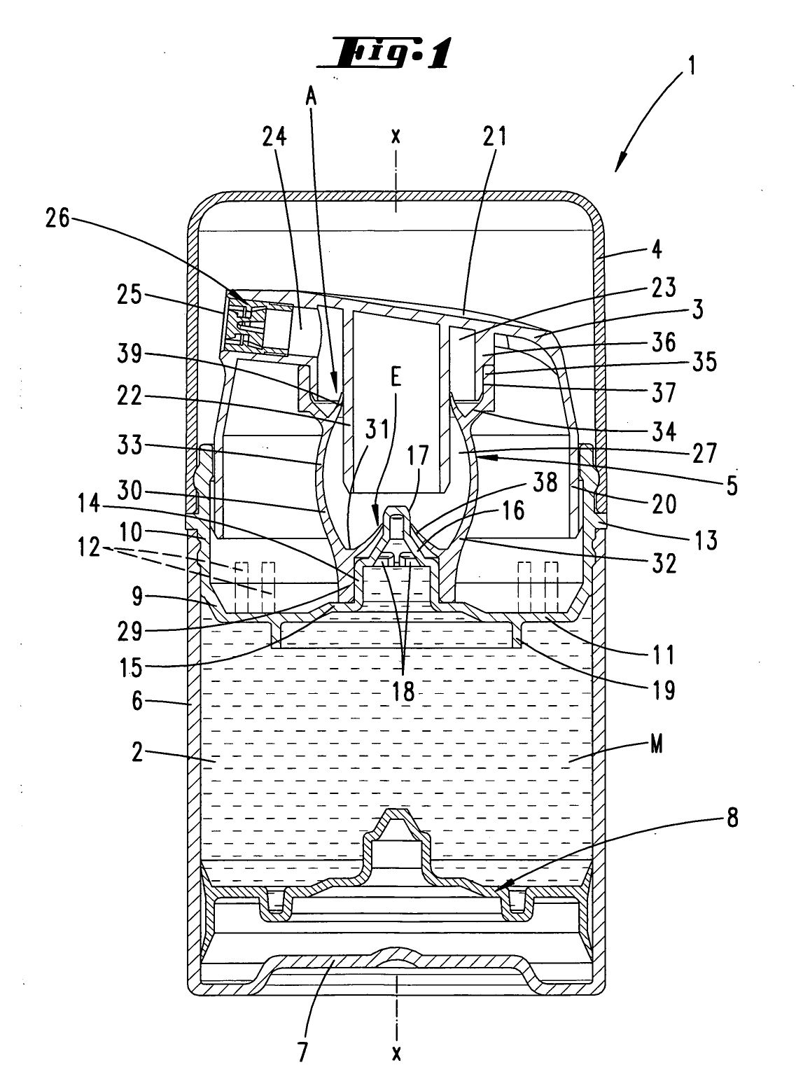

FIG. 1 shows a longitudinal section through dispenser of the type in question in a first embodiment, for a basic position of the dispenser in which it is covered with a cap;

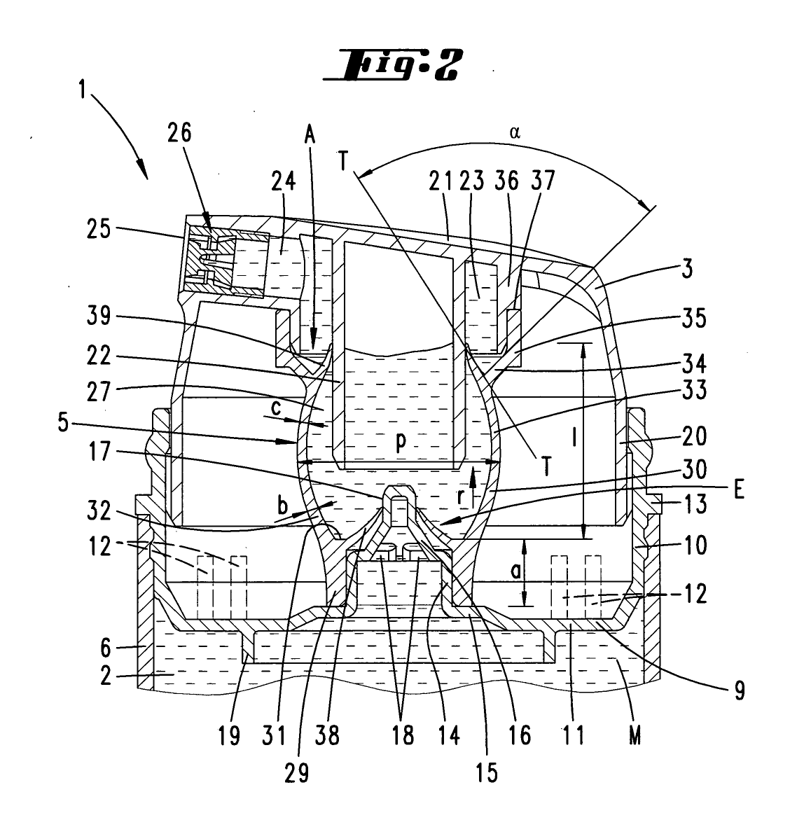

FIG. 2 shows the region of the dispenser head piece, illustrated in an enlarged section, in a readiness position without the covering cap, after an initial actuation of the dispenser;

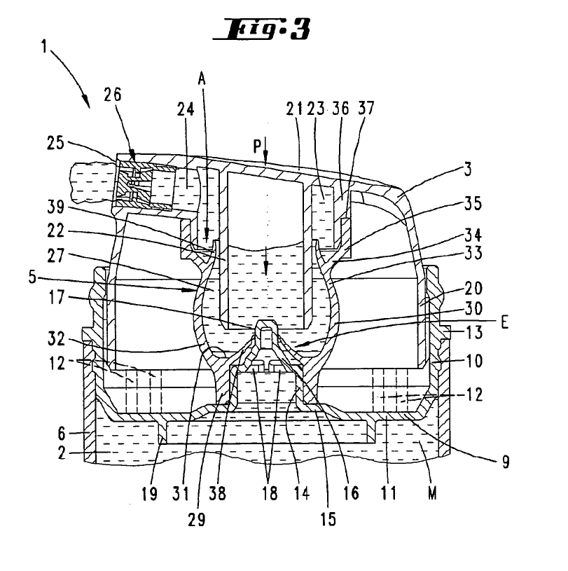

FIG. 3 shows a sectional representation corresponding to FIG. 2, for the dispenser in the course of a pumping movement for the dispensing of substance;

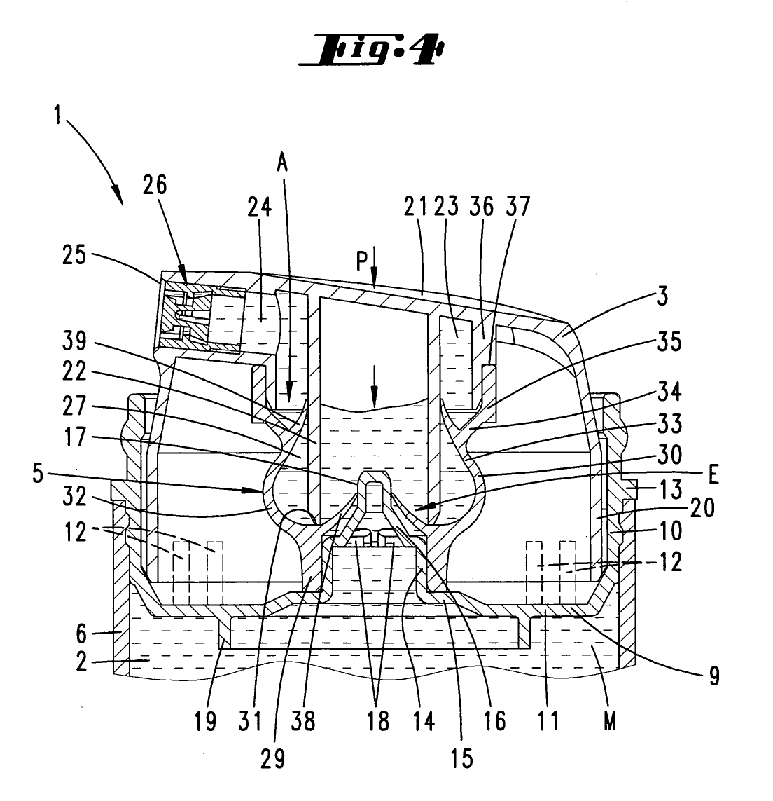

FIG. 4 shows the dispenser in a pumping end position after dispensing of the substance;

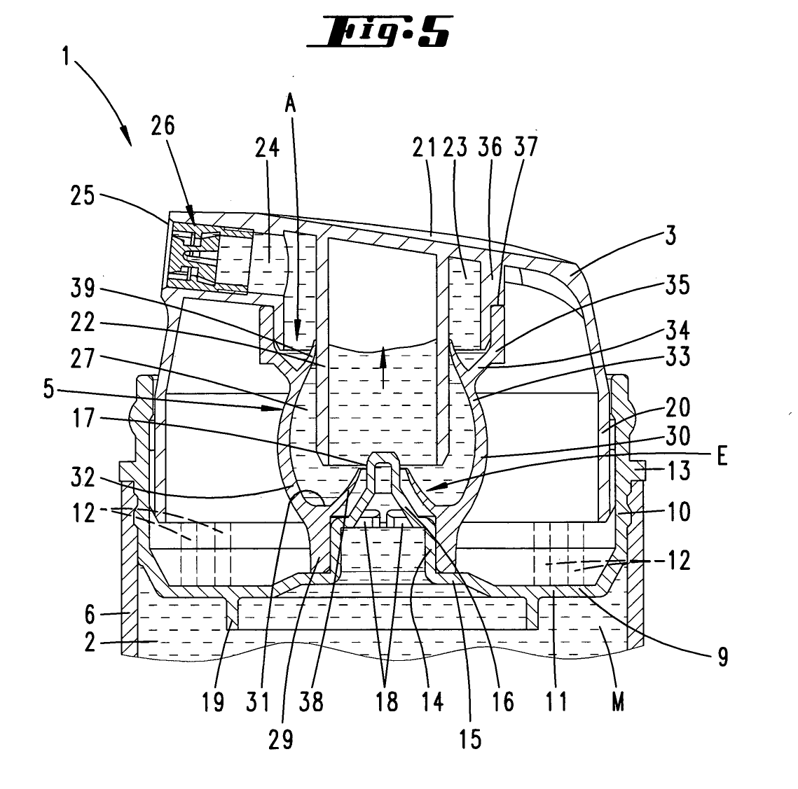

FIG. 5 shows a representation following on FIG. 4, for the return of the dispenser head piece;

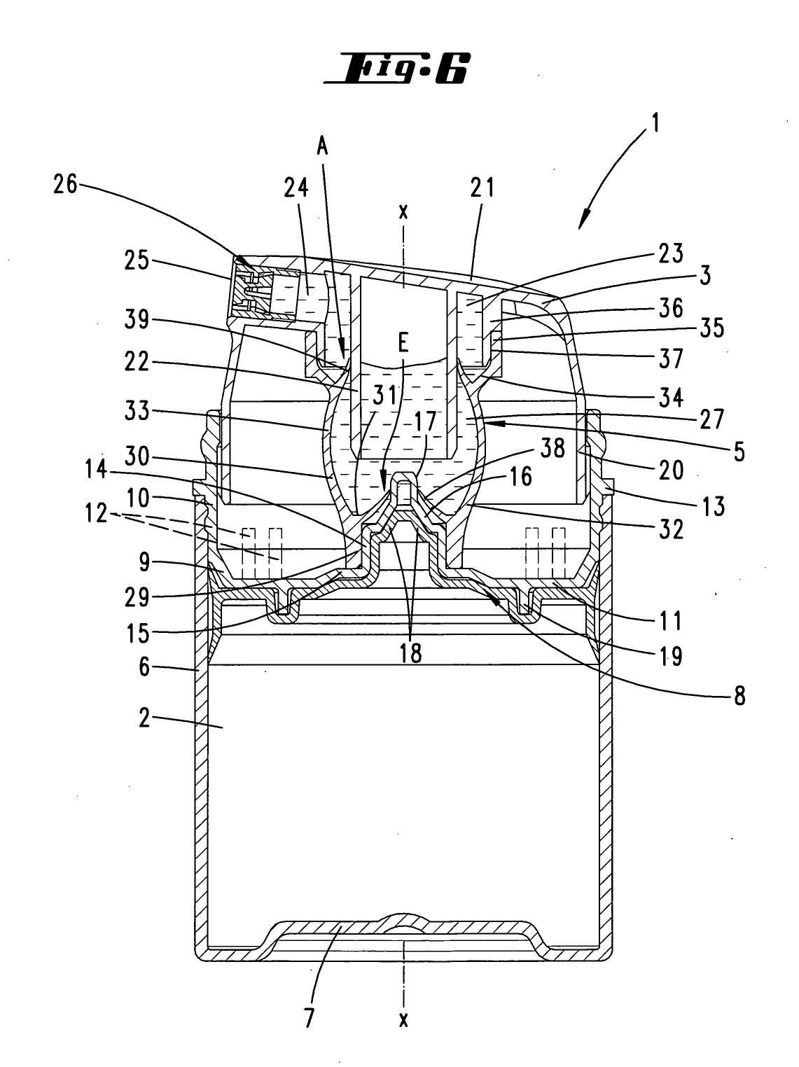

FIG. 6 shows the dispenser in a representation according to FIG. 1, but after emptying of the substance reservoir;

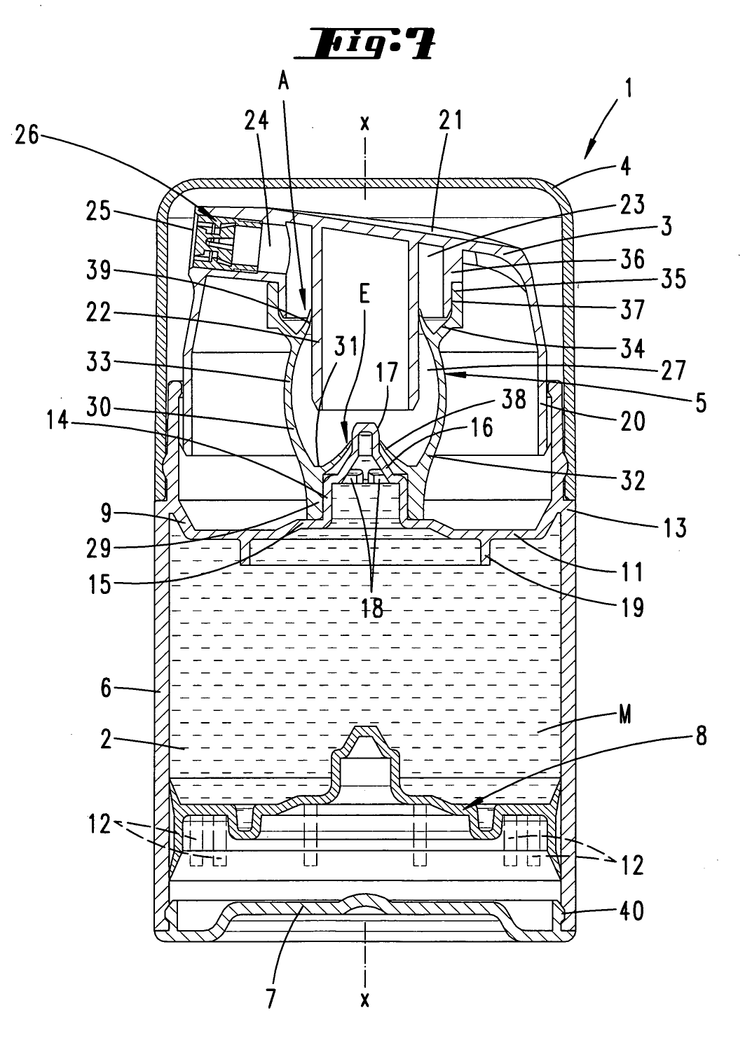

FIG. 7 shows a representation corresponding to FIG. 1, but for a second embodiment,

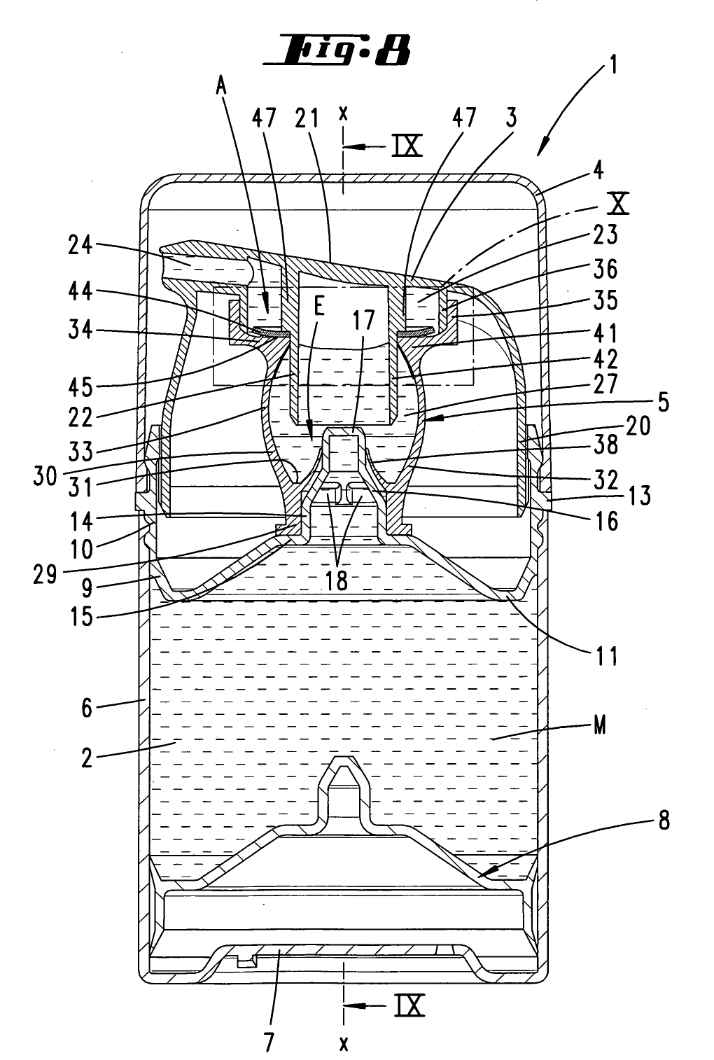

FIG. 8 shows a representation corresponding to FIG. 1, but for a third embodiment;

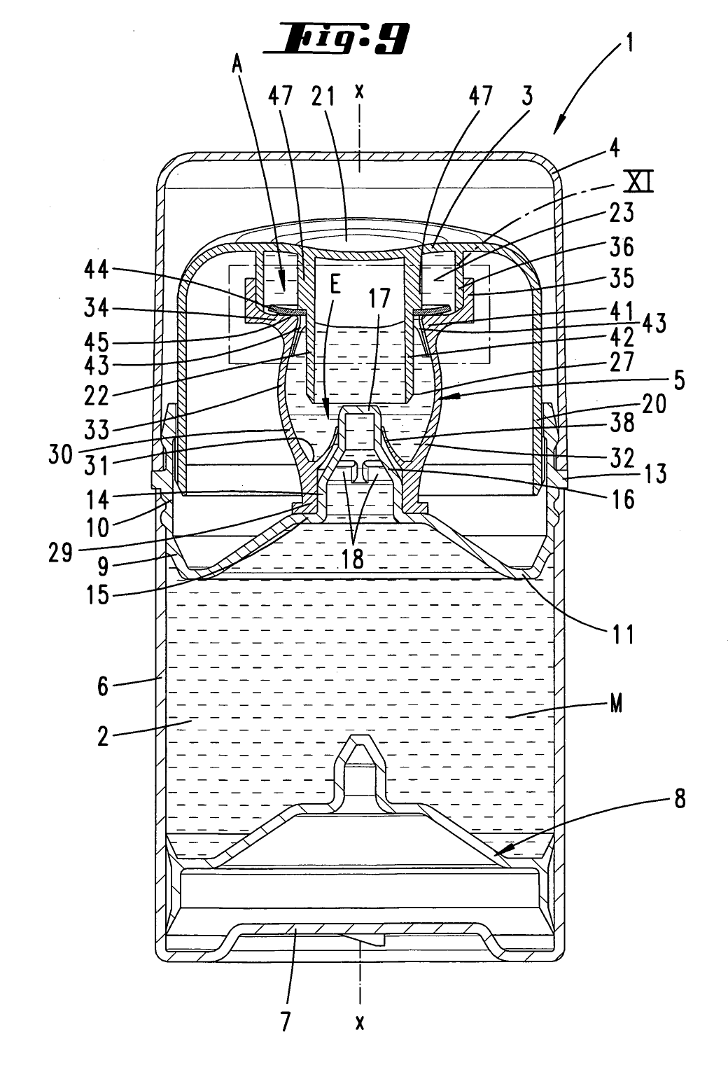

FIG. 9 shows a further longitudinal sectional representation of the dispenser according to FIG. 8, but in a section plane offset in plan view by 90°;

FIG. 10 shows the enlargement of the region X in FIG. 8;

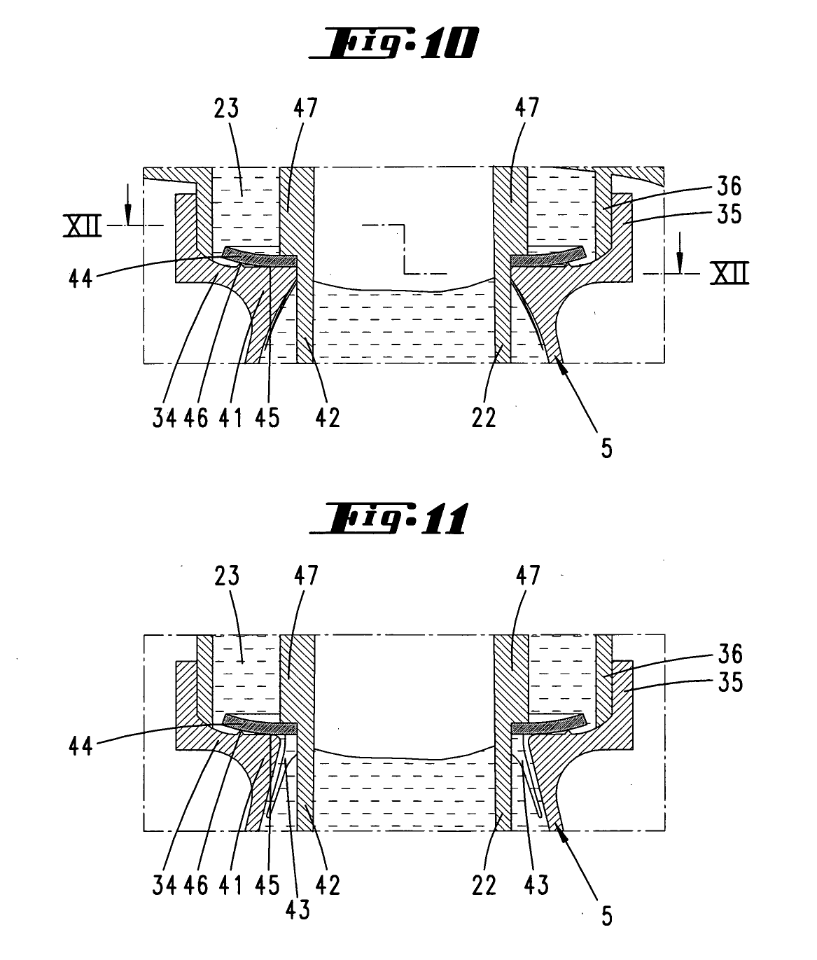

FIG. 11 shows the enlargement of the region XI in FIG. 9;

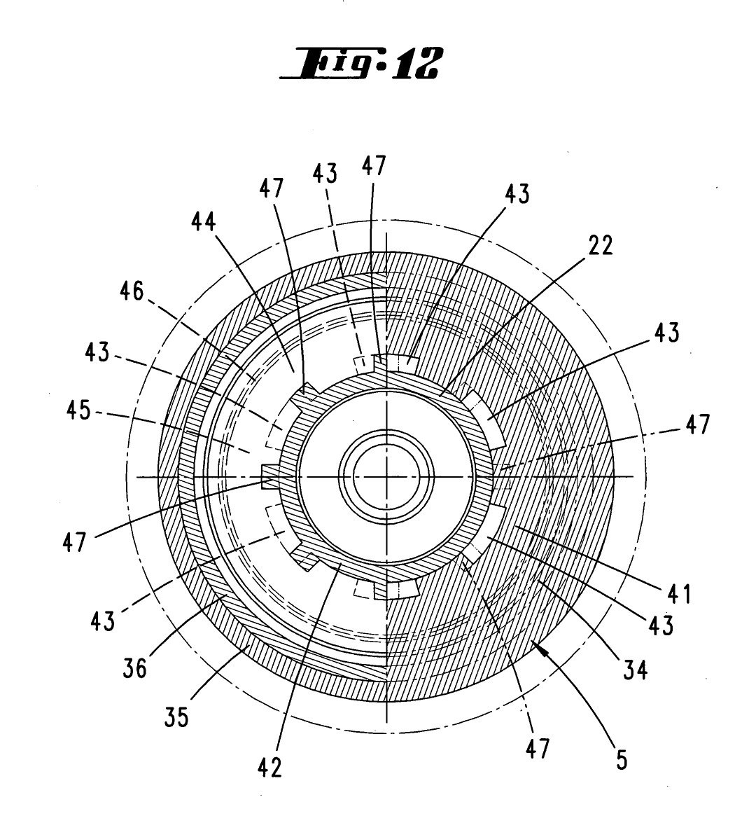

FIG. 12 shows the offset section along the line XII-XII in FIG. 10;

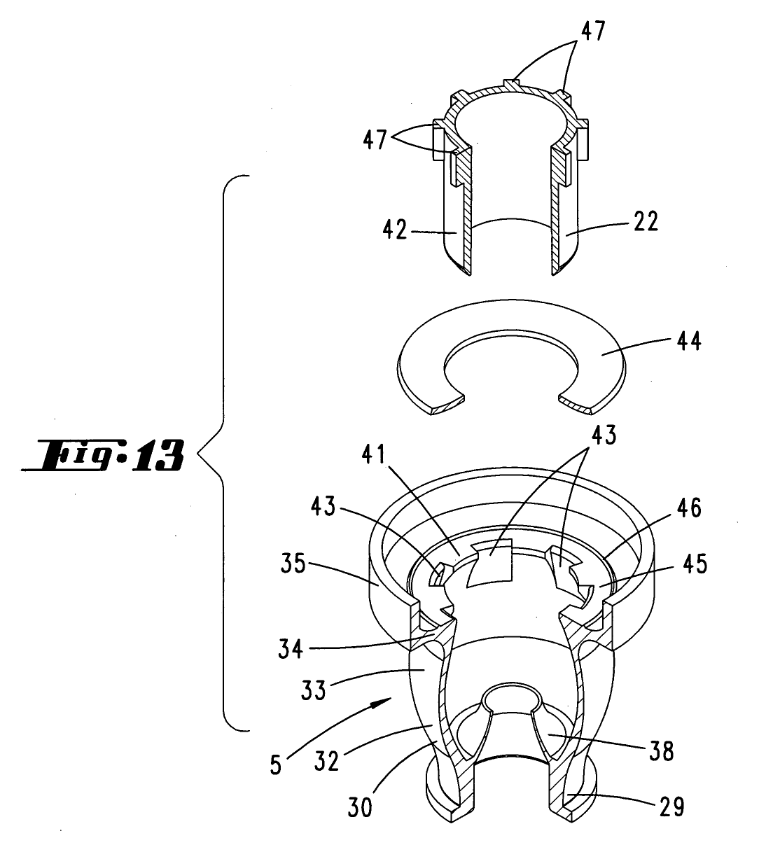

FIG. 13 shows a pumping chamber body of the third embodiment as well as a flat-part seal and a head-piece tube portion, in a perspective, partially sectioned representation;

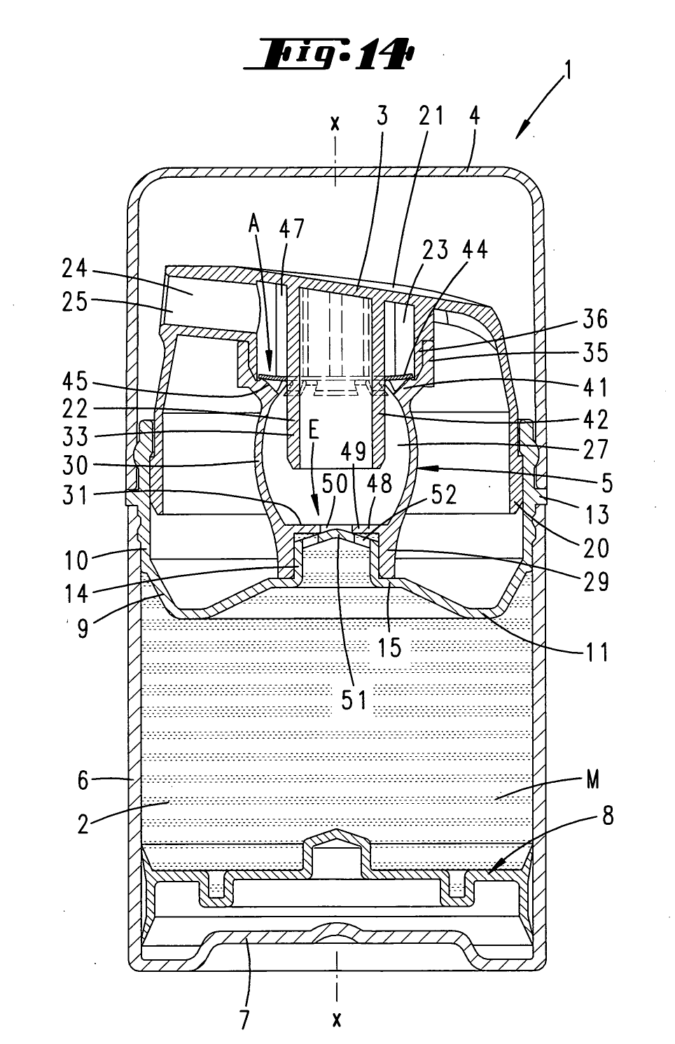

FIG. 14 shows a longitudinal sectional representation corresponding to FIG. 1 through a dispenser in a further embodiment;

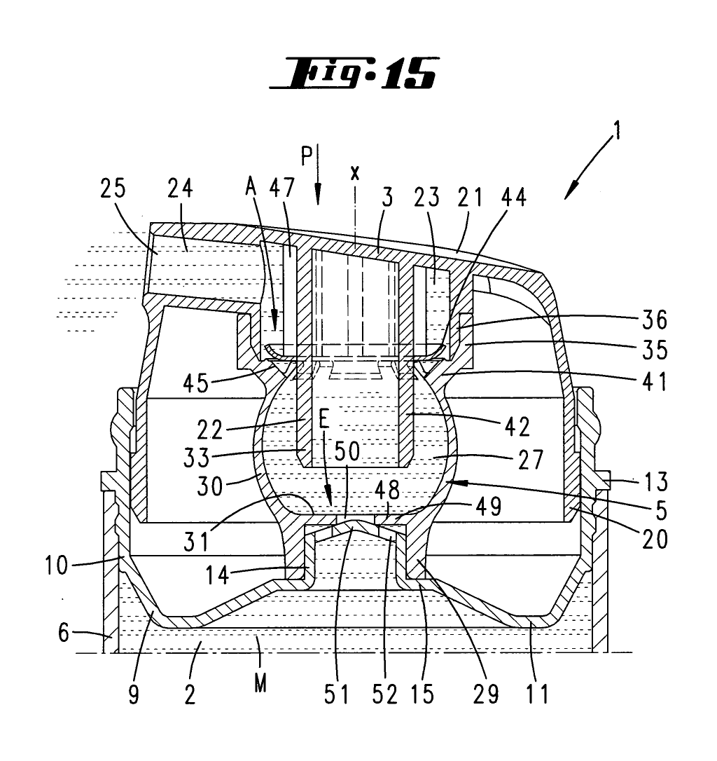

FIG. 15 shows the region of the dispenser head piece without the covering cap, represented in section, in the course of an actuation of the dispenser;

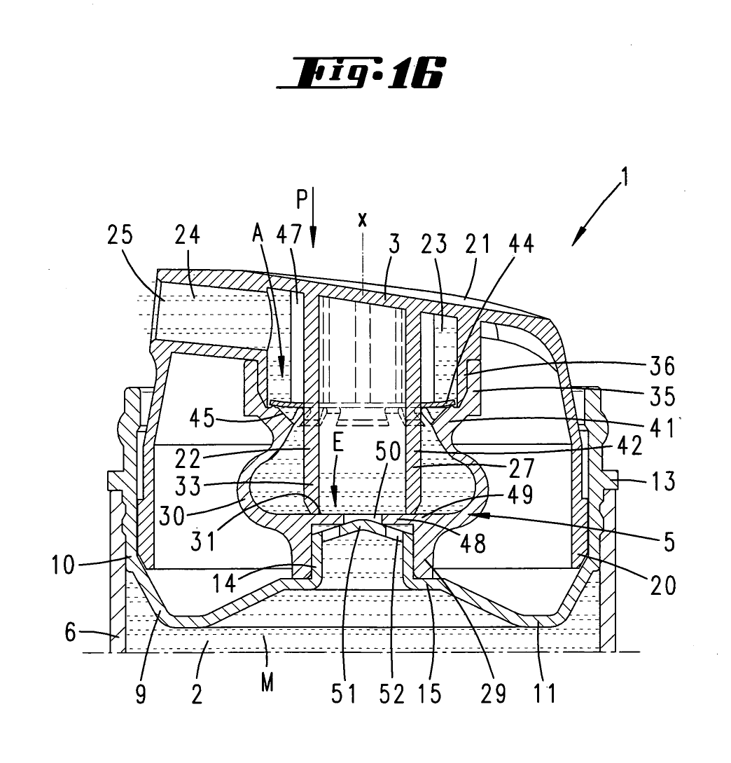

FIG. 16 shows the dispenser in a pumping end position after dispensing of the substance;

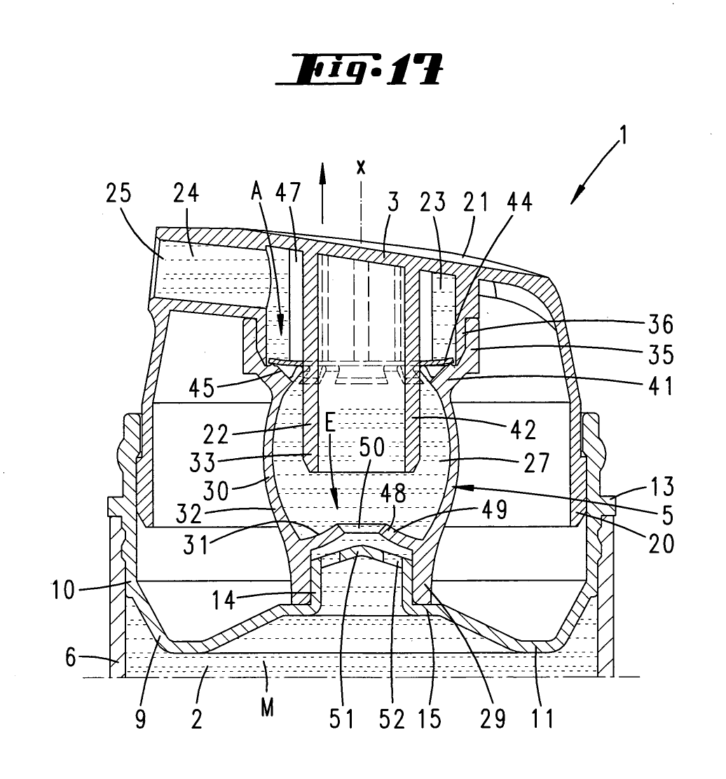

FIG. 17 shows a representation following on FIG. 16, for the return of the dispenser head piece;

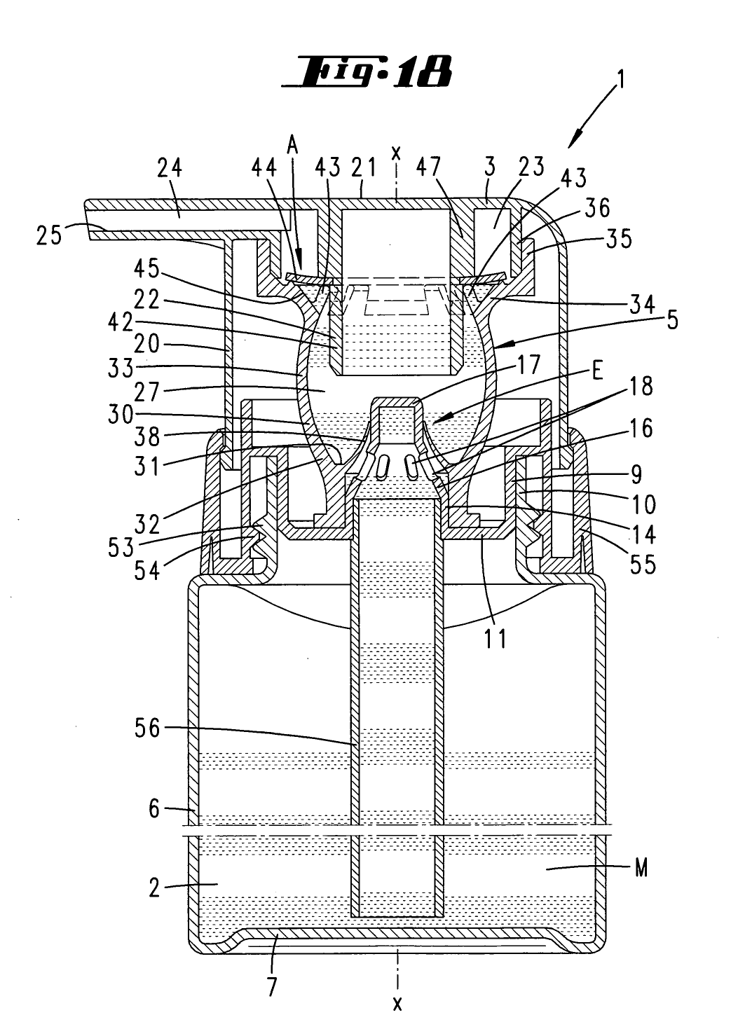

FIG. 18 shows a representation according to FIG. 1, for a further embodiment of the dispenser;

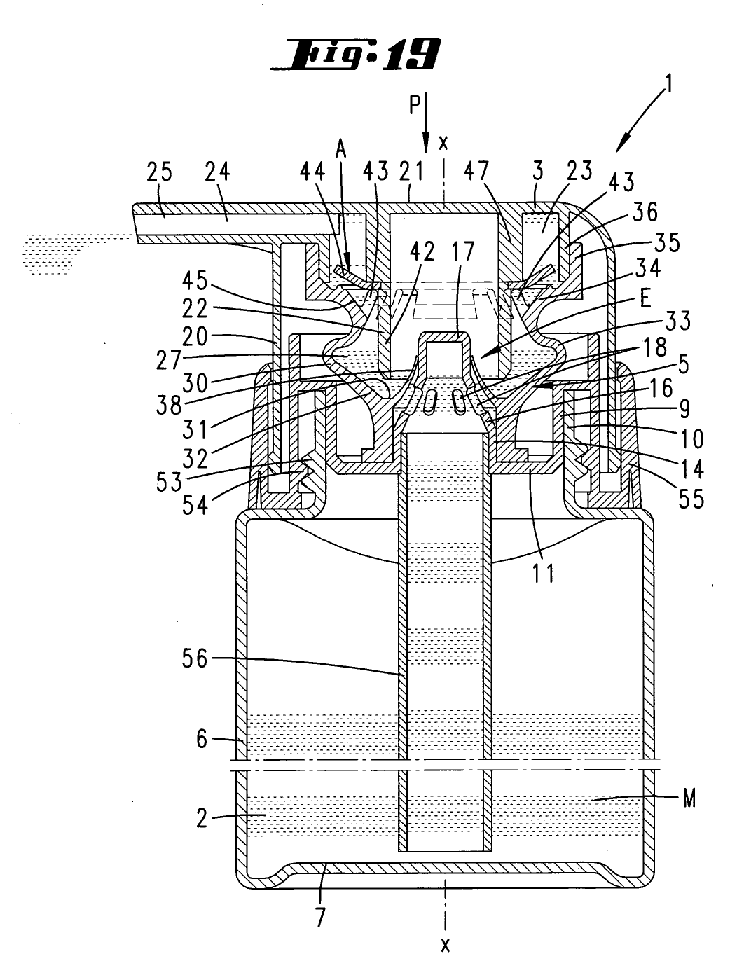

FIG. 19 shows a representation corresponding to FIG. 18, for the dispenser in the course of a pumping movement for the dispensing of substance;

FIG. 20 shows a representation following on FIG. 19, for the return of the dispenser head piece;

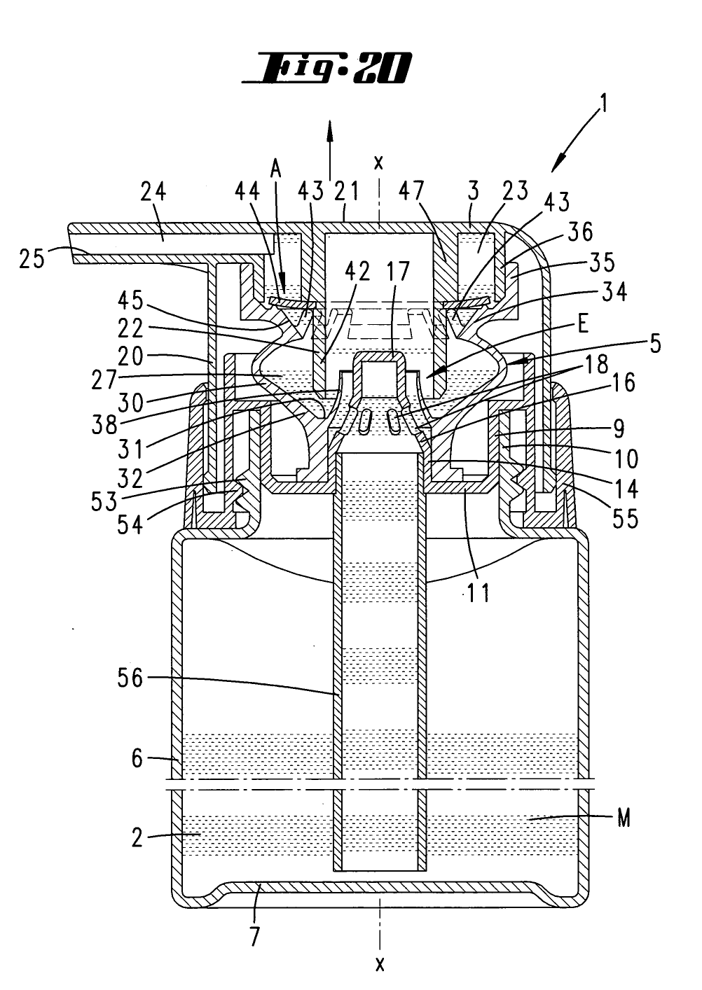

FIG. 21 shows a longitudinal sectional representation corresponding to FIG. 1 through a dispenser in a further embodiment;

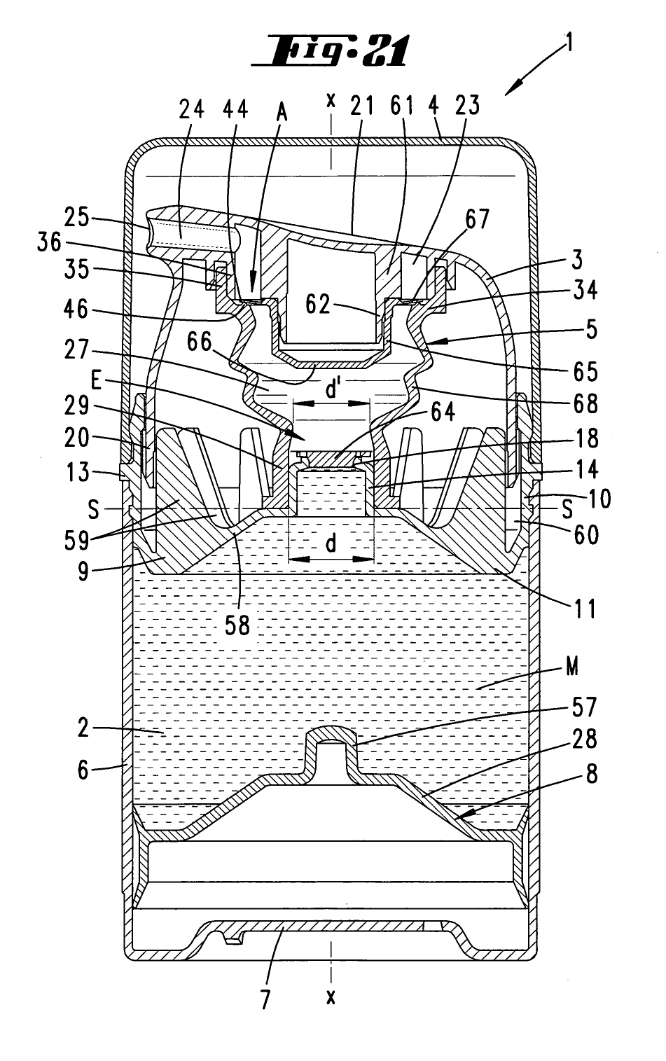

FIG. 22 shows the region of the dispenser head piece without the covering cap, represented in section, in the course of an actuation of the dispenser;

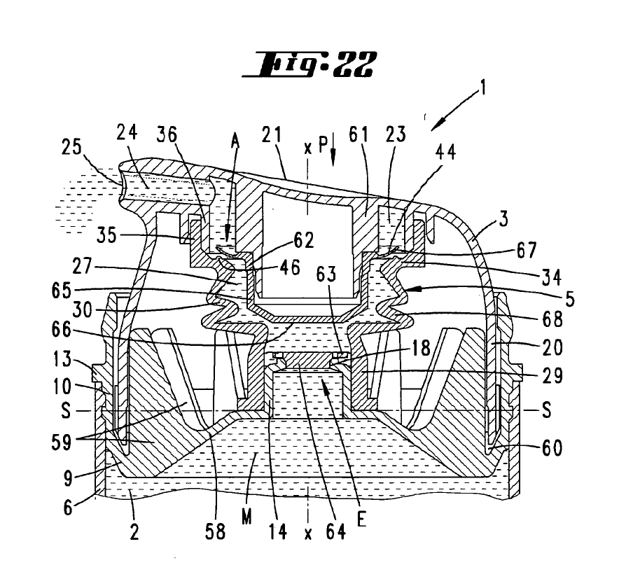

FIG. 23 shows a representation corresponding to FIG. 22, but for an intermediate position in the course of the return of the dispenser head piece;

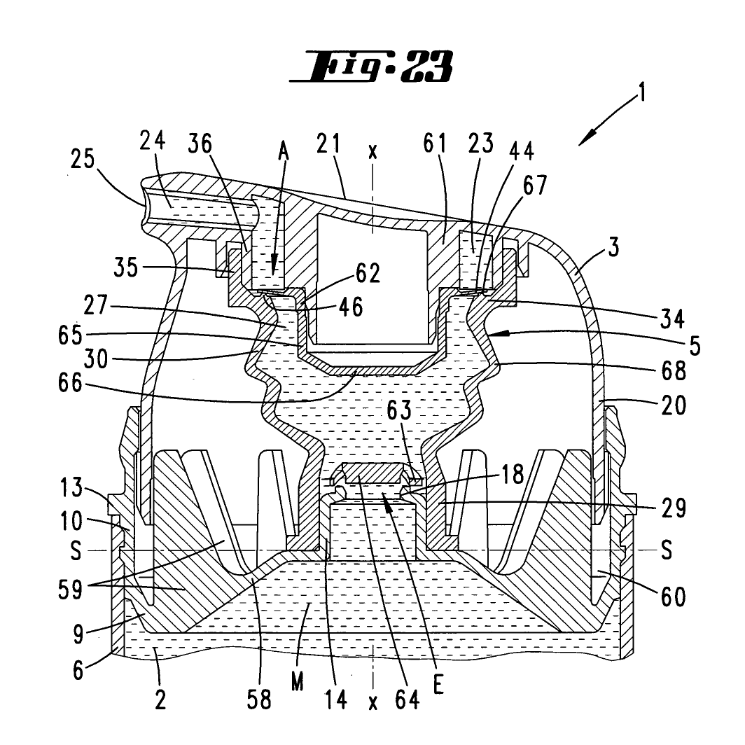

FIG. 24 shows the pumping chamber body with a molded inlet valve, associated outlet valve and associated chamber closure part, in a perspective, partially sectioned representation;

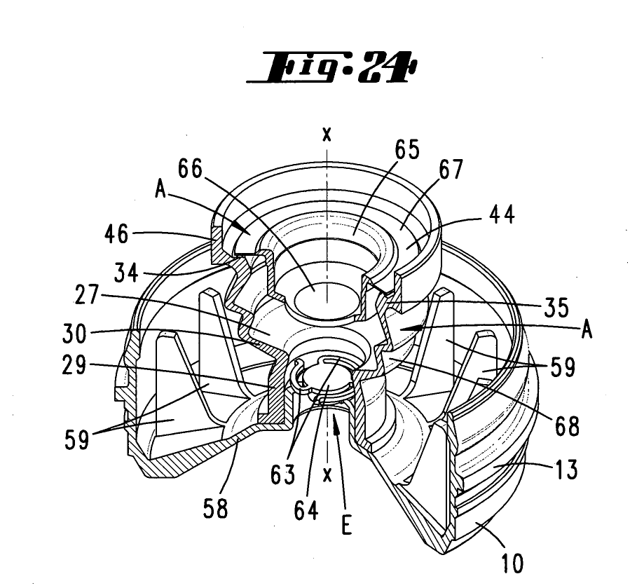

FIG. 25 shows an enlargement of the inlet valve region in the valve closure position according to FIG. 22;

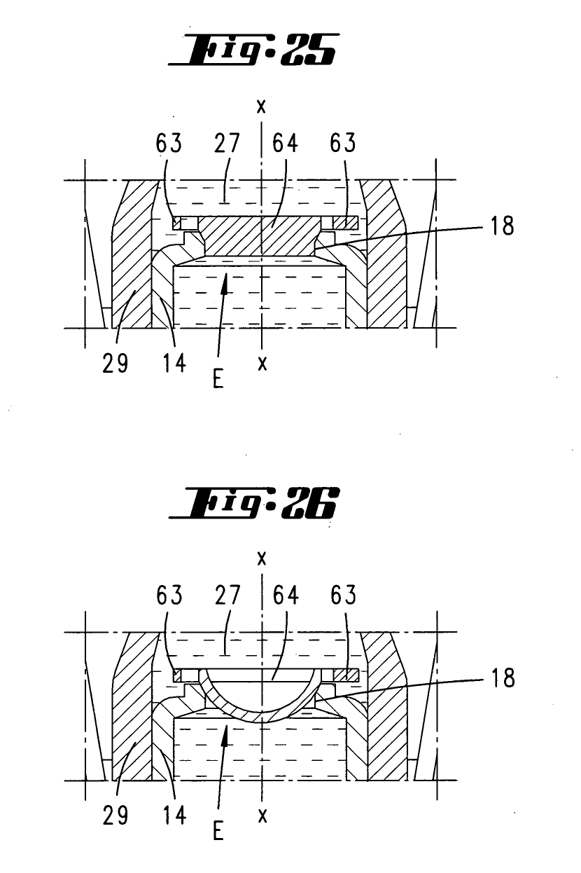

FIG. 26 shows a representation corresponding to FIG. 25, but for an alternative configuration;

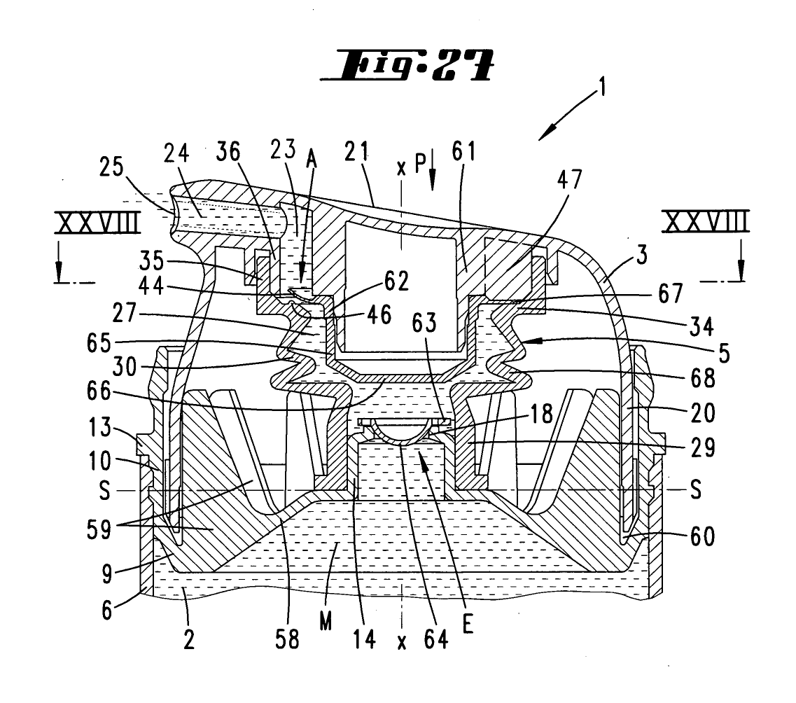

FIG. 27 shows a representation corresponding to FIG. 22, for a further embodiment;

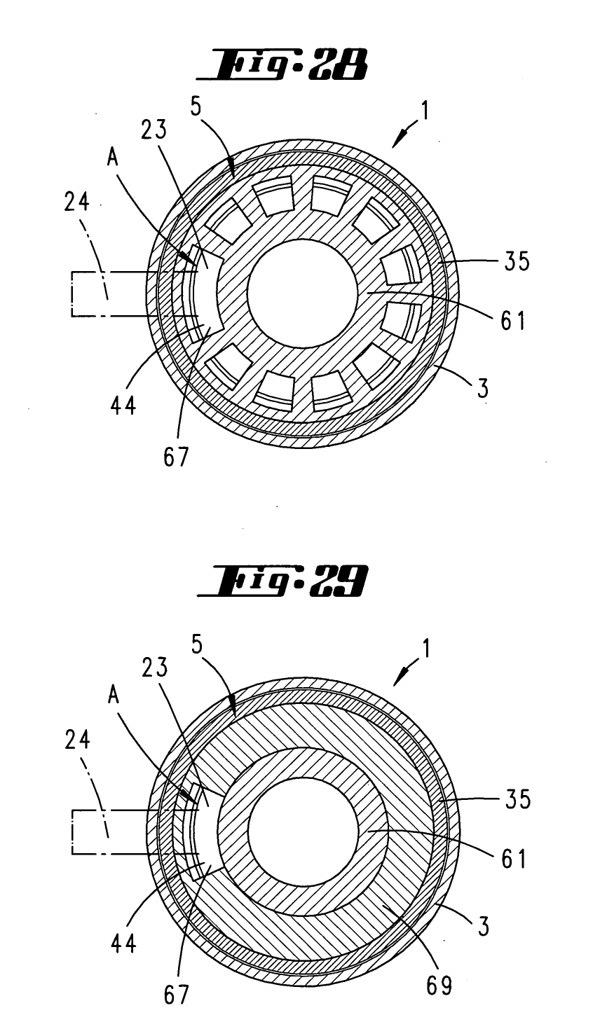

FIG. 28 shows the cross-section along the line XXVIII-XXVIII in FIG. 27;

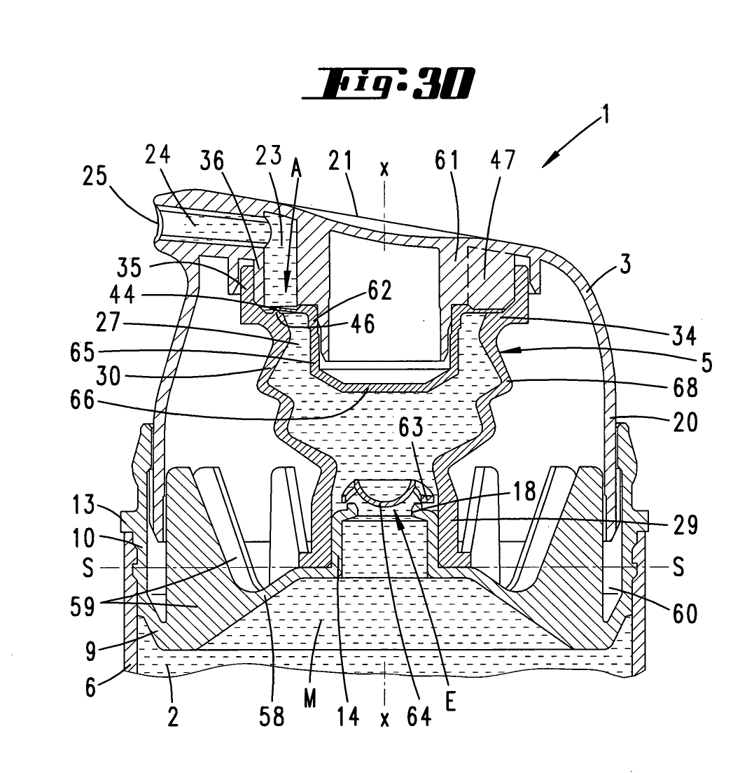

FIG. 29 shows the cross-section according to FIG. 28, for an alternative embodiment;

FIG. 30 shows a representation corresponding to FIG. 23, for the embodiment according to FIG. 27.

Represented and described in first instance with reference to FIG. 1 is a first exemplary embodiment of a dispenser 1. This is substantially made up of a hollow-cylindrical substance reservoir 2 with a head piece 3, which is coupled to said reservoir and, in the not-in-use position represented, is covered over by a cap 4.

The molded parts of the dispenser 1 predominantly consist of a plastics material, such as for example polyethylene, and are produced by the injection-molding process. An exception to this is a pumping chamber body 5, described below. This is produced from a soft plastics material, for example from an elastomer, TPE or a silicone material.

In the first exemplary embodiment, the container 6 surrounding the reservoir 2 has a container base 7 which is substantially closed (optionally apart from a vent that is not represented). The opening of the container faces in the direction of the head piece 3.

Positioned in the storage container 6 is a feeding piston 8, by way of which the substance M to be dispensed is transported in the direction of the head piece 3.

The upwardly open container 6, and consequently the reservoir 2 filled with substance M from above, is covered over by a chamber closure part 9. This is initially shaped in the manner of a cup, with an annular wall 10, lying against the container wall over part of its height on the inner side, and a base 11, initially directed substantially perpendicularly in relation to a dispenser axis x. The chamber closure part 9 is inserted from above into the opening of the container 6, thereby displacing the air trapped between the base 11 and the level of the filled substance M, by way of axially directed short grooves 12 provided on the inner wall of the container 6. The chamber closure part 9 engages in a latching manner with the container wall in the region of the annular wall 10. An annular collar 13, protruding radially outward approximately halfway up the annular wall 10, rests on the facing circular end face of the container wall. The portion of the annular wall 10 protruding vertically upward beyond the radial collar 13 serves, on the inner side of the wall, for guiding the head piece 3, and on the outer side of the wall, for the locking engagement of the covering cap 4 to be placed on, which latter in turn rests on the radial collar 13 in a circumferential manner with its free circular-ring face.

Centrally oriented at the axis x, the base 11 curves up in the direction of the head piece 3, to form a central dome. This is initially shaped in the form of a tube portion with a circular cross-section. This tube portion 14 is on an elevation 15, formed from the base 11, the degree of elevation when considered in the axial direction corresponding approximately to the material thickness of the base 11.

The outer diameter of the tube portion 14 corresponds approximately to the vertical distance, or the distance measured in the axial direction, between the end face of the tube portion 14, facing the head piece 3, and the underside of the base 11, facing the reservoir 2.

With an annular top portion thereof interposed, the tube portion 14 merges into a cone portion 16, which narrows in the direction of the head piece 3 and is followed by a cap portion 17 with a circular cross-section. The diameter of the cap portion 17 corresponds approximately to 0.3 times the outer diameter of the tube portion 14. The cap portion 17 is closed on the wall side and in the direction of the head piece 3. The cap opening faces downward in the direction of the reservoir 2.

The height of the cone portion 16 and the cap portion 17, measured in the axial direction, corresponds approximately to the height of the tube portion 14, measured in the same direction.

In the foot region of the cone portion 16, four passage openings 18 are formed from the wall in such a way that they are uniformly distributed over the circumference. These openings are positioned such that they partly break through the wall of the cone portion 16 and partly break through the top wall connecting the cone portion 16 to the tube portion.

The base 11 is provided on the underside, i.e. facing the reservoir 2, with an axially aligned annular collar 19, the axial length of which, when considered from the underside of the base, corresponds approximately to 3 times the material thickness of the base 11 or of the annular collar 19. The inner diameter of the annular collar 19 further corresponds approximately to 0.5 times the outer diameter of the container.

The feeding piston 8 is cross-sectionally adapted substantially to the opposing contour of the base 11 and of the dome rising up from the base, with the exception of the cap portion 17 at the tip, so that virtually complete emptying of the storage container 6 can be achieved when the piston 8 is displaced completely, as shown by the representation in FIG. 6.

The head piece 3 is formed substantially in the manner of an inverted cup, i.e. with the cup opening facing downward in the direction of the chamber closure part 9. The head piece wall 20, which in the same way as the container 6 is formed rotationally symmetrically with respect to the axis x, engages in the upwardly open cup space of the chamber closure part 9, guidance of the head piece 3 being achieved on the annular wall 10 of the chamber closure part 9 when there is a vertical displacement along the axis x, with the head piece wall 20 being supported on the inner wall.

The top of the head piece 3, which in cross-section runs at an acute angle in relation to a perpendicular to the axis x, forms an actuating area 21 on the upper side.

On the inner side of the cup of the head piece 3, i.e. on the underside of the actuating area 21, facing away from the top of the head piece in the direction of the chamber closure part 9, a tubular pressing-in formation 22 is formed from the same material as, and in one piece with, the head piece 3. This formation has an inner diameter which corresponds substantially to the outer diameter of the tube portion 14 of the chamber closure part. The head piece wall 20 and the pressing-in formation 22 are aligned concentrically with respect to the axis x, the axial length of the pressing-in formation 22, formed as downwardly open, i.e. in the direction of the chamber closure part 9 or of the centrally formed dome thereof, corresponding approximately to 1.4 to 1.8 times the outer diameter of this formation.

In the exemplary embodiment represented, the free end of the pressing-in formation 22 is provided with a circumferential bevel on the outer wall.

Extending from the root region on the underside of the top of the head piece, the pressing-in formation 22 passes through a concentrically disposed dispensing chamber 23. This chamber is approximately half the axial height of the formation 22 and merges into a dispensing channel 24 protruding substantially radially outward in relation to the chamber. This channel extends obliquely upward from the dispensing chamber 23, adapted to the slope of the actuating area 21 with reference to the illustrations, to form a dispensing opening 25 at the end. In the region of the dispensing channel 24, associated with the dispensing opening 25, there may be a foam valve 26 disposed in the way represented. Provision of such a foam valve 26 is not essential. The dispenser 1 may also be operated with a free dispensing channel 24. In addition, it is for example also possible for a self-closing valve to be located in the dispensing channel 24.

The dispensing chamber 23 and the reservoir 2 are coupled by way of a pumping chamber 27. This is formed by the pumping chamber body 5 of spring-elastic plastics material.

The pumping chamber body 5 firstly has, in the bottom region, a base securing portion 29, formed as an annular collar. This is formed in the manner of a sleeve, rotationally symmetrically with respect to the axis x, and has an inner diameter and axial height in the inner region that are adapted to the outer diameter and the axial height of the tube portion 14 of the chamber closure part 9. Accordingly, the inner wall of the base securing portion 29 encloses the tube portion 24 in a clamping manner, while furthermore the annular rim, facing downward in the direction of the chamber closure part 9, rests on the plane of the elevation 15 that follows on radially outward from the tube portion 14. The base securing portion 29 has a thickness, measured in the radial direction, that corresponds approximately to two times the material thickness of the chamber closure part 9, in particular of the tube portion 14. Thus, in the exemplary embodiment represented, a radial material thickness in this respect of approximately 1.8 mm is provided, this furthermore with an axial extent a of the base securing portion 29 of 6.3 mm in the exemplary embodiment represented.

It follows from this that, at least inwardly facing, the base securing portion 29 protrudes axially beyond the tube portion 14, this furthermore approximately by the dimension of the material thickness of the tube portion 14.

Lying opposite the free end area of placement of the base securing portion 29, a pumping chamber wall 30 emerges circumferentially. The circumferential root region of the pumping chamber wall 30 is associated with the radially outer region of the base securing portion 29, this furthermore while leaving a planar area of action 31, in the shape of a circular ring in a vertical projection, on the end face of the base securing portion 29 that lies opposite the area of placement and faces in the direction of the head piece 3. The radially inner circular-ring contour of the area of action 31 in a vertical projection lies approximately on the circumference line of the tube portion 14, while the radially outer circular-ring line of the area of action 31 in a vertical projection is formed approximately in the middle of the wall of the base securing portion.

Extending from the root region on the base securing portion 29, the pumping chamber wall widens continuously up to a maximum, from which the pumping chamber wall 30 in turn narrows continuously. In a longitudinal section according to the representation in FIG. 1, this produces, in an un-pressed basic position, an elliptical, moreover approximately tulip-shaped form, with a widened portion 32, associated with the base securing portion 29, and a narrowing portion 33 that follows this and faces the head piece 3.

Associated with the root region, the pumping chamber wall 30 has a wall thickness b of slightly more than 1 mm, thus for example 1.3 mm. This wall thickness is reduced toward the middle region, i.e. toward the transitional region from the widening portion 32 to the narrowing portion 33, to a wall thickness c of 0.8 mm in the exemplary embodiment. This reduced wall thickness c is substantially maintained over the entire narrowed portion 33.

The widening portion 32 merges at the outer wall into the outer wall of the base securing portion 29 by way of a formation that is convex when considered from the outside.

At the free end facing away from the base securing portion 29, the pumping chamber wall 30 carries a transitional wall 34, formed from the same material and in one piece and extending in a flared manner from the pumping chamber wall 30. In the exemplary embodiment represented, this transitional wall forms an angle alpha of approximately 80° with a local tangent T. This transitional wall 34 carries an annular thrust collar 35 at the end. This is positioned rotationally symmetrically with respect to the axis x, the inner wall of the thrust collar 35 in a vertical projection lying outside the pumping chamber wall 30, thus furthermore, in the exemplary embodiment represented, with a radial spacing of less than half the minimum thickness dimension of the pumping chamber wall 30. In a way corresponding to this disposition, the outer wall of the thrust collar in a vertical projection also lies outside the pumping chamber wall 30, the radial thickness of the thrust collar 35 being chosen furthermore to be slightly less than the material thickness, measured in the same direction, of the base securing portion 29, thus furthermore, in the exemplary embodiment represented, accordingly approximately 1.3 mm. The height, measured in the axial direction, of the thrust collar 35 in the exemplary embodiment represented is made to be approximately 5.4 mm.

The thrust collar 35 engages around the dispensing channel wall 36, which is in the form of a tube portion, of the dispensing chamber 23 in the region of a correspondingly formed annular step 37. The thrust collar 35 engages in the annular step 37 in a clamping manner.

Radially on the inside in the region of the area of the base securing portion 29 that rises up above the tube portion 14, an inwardly facing inlet valve E is molded from the same material and in one piece in the form of a circular-ring-shaped lip 38. This lip 38 is convexly shaped, when considered in the direction r in which the substance M passes through, and comes to a point in the direction of the inwardly facing free end. With the pointed peripheral lip region, the lip 38 lies in a sealing manner against the circumferential wall of the rotationally symmetrically formed cap portion 17.

An outlet valve A is also formed on the pumping chamber body 5 from the same material and in one piece. This valve is also formed annularly as a lip 39, which is rooted in the transitional region from the pumping chamber wall 30 to the transitional wall 34 and initially follows approximately the curvature of the narrowing portion 33 of the pumping chamber wall 30. The free pointed lip region lies in a sealing manner against the rotationally symmetrical outer wall of the pressing-in formation 22, which pressing-in formation 22 accordingly forms at the same time the sealing seat. When considered in the direction r in which the substance passes through, the outlet valve A is also convexly curved.

The lip 39 of the outlet valve A protrudes into the region of the dispensing chamber 23, but ends at an axial distance from the free end face of the thrust collar 35.

The pumping chamber wall 30 has over its length, when considered in the axial direction, different radii defining the curvature. Thus, in the region of the widening portion 32, a radius that is greater in comparison with the narrowing portion 33 is provided, thus for example a radius of 19 mm as compared with a radius of 15.8 mm.

As a result of the configuration and disposition of the pumping chamber body 5, the pressing-in formation 22 passes through the dispensing chamber 23 and protrudes into the pumping chamber 27, while the downwardly facing free end of the pressing-in formation 22 remains at a distance vertically from the associated area of action 31 of the base securing portion 39 in a basic position according to FIGS. 1 and 2.

The pumping chamber wall 30, the transitional wall 34, the thrust collar 35, the base securing portion 29 and the lip valves 38 and 39 are formed in one piece, from the same material.

The pumping chamber body 5 has an axial length l which in the un-pressed basic position corresponds approximately to the width p, the significant lengths and widths only concerning the region accommodating the substance. Thus, the width is to be understood as meaning the dimension in the region of the maximum diameter of the pumping body wall and the axial length is to be understood as meaning the axial distance between the area of action 31 and the tip region of the outlet valve lip 39.

The following mode of operation is obtained:

By applying pressure to the head piece 3, on the actuating area 21 (see arrow B), a vertical downward displacement of the head piece (3), and thereby of the pressing-in formation 22, is brought about, this, furthermore, with the pumping chamber wall 30 being made to bulge by the thrust collar 35 according to the representation in FIG. 4. This deliberate bulging of the pumping chamber wall 30 is achieved by the choice of different material thickness. Moreover, sudden collapsing of the wall is counteracted.

The positive pressure thereby built up in the pumping chamber 27 has the effect that the substance M that is present in the pumping chamber 27 and the dispensing chamber 23 is forced out by way of the dispensing channel 24, the lip 39 of the outlet valve A being displaced into an open position. The lip 38 of the inlet valve E, on the other hand, is forced even more securely into its sealing seat with respect to the cap portion 17.

In the completely lowered position of the head piece according to FIG. 4, the free end of the tube of the pressing-in formation 22 engages against the area of action 31 of the base securing portion 29 of the pumping chamber body 5, so that, as a result of being acted upon in this way, the latter is forced into the seating on the tube portion 14 and, furthermore, against the standing area of the elevation 15 of the chamber closure part 9. Thus, the correct seating of the pumping chamber body 5 can be achieved by an initial actuation.

After letting go of the head piece 3, and accordingly no longer applying pressure (arrow P), the elastic returning or righting movement of the pumping chamber wall 30 causes the head piece 3 to return. The suction produced as a result has the effect not only of opening the outlet valve A but also of drawing substance M out of the reservoir 2, by way of the passage opening 18, to replenish the pumping chamber 27. In the course of this sucking movement, the lip 39 of the outlet valve A is pressed more securely against the sealing seat (outer wall of the pressing-in formation 22).

The hollow cylinder forming the pressing-in formation 22 may be closed with a plug, while taking into account the dome of the chamber closure part 9 protruding into the tube portion in the completely lowered position. Furthermore, further functional parts may also be accommodated in the tube portion forming the pressing-in formation 22.

The pumping chamber 27 or the pumping chamber wall 30 is coated on the inner side, for example by dipping or spraying.

A further embodiment is represented in FIG. 7. This only differs from the embodiment described above by the configuration of the container 6. Here, the chamber closure part 9 is formed from the same material, in one piece with the container wall. On the other hand, the container base 7 is separately formed and can be fixed to the container 6 by way of a locking means 40. In the case of this embodiment, the container 6 is filled from below, after which the feeding piston 8 is pushed in, thereby displacing the air trapped between the level of the substance M and the facing piston area, by way of the grooves 12 also provided here on the wall.

A further embodiment of the dispenser 1, which has substantially the same configuration as that of the exemplary embodiments described above, in particular the first exemplary embodiment, is illustrated in FIGS. 8 to 13. The only major difference is with regard to the outlet valve A and the associated configuration of the pumping chamber body 5. The inlet valve E, on the other hand, is formed in the same way as in the exemplary embodiments described above as a lip seal, formed as one part with the pumping chamber body 5.

The pumping chamber body of the third embodiment has, extending from the area of action 31 on the inlet valve, an initially widening portion 32, which merges continuously into a portion 33 that narrows upwardly in the direction of the pressing-in formation 22. This portion ends in a thickened ring portion 41 with an inner diameter which corresponds to the outer diameter of the pressing-in formation 22 formed as tube portion 42. Radially on the outside, the ring portion 41 carries a transitional wall 34, which is directed approximately horizontally, that is to say transversely in relation to the dispenser axis x, and, as in the exemplary embodiments described above, at the end carries the thrust collar 35.

As can be gathered in particular from the representations in FIGS. 12 and 13, the ring portion 41 is provided with cutouts 43 in the region where it lies in contact with the lateral wall of the tube portion 42. In the exemplary embodiment represented, six such cutouts 43 are formed, uniformly spaced apart from one another over the circumference of the contact zone of the ring portion 41. In the region of these cutouts 43, the ring portion 41 is not in contact with the lateral surface of the tube portion 42. Correspondingly, in the region of the cutouts 43, the pumping chamber body 5 or the ring portion 41 extends with a radial spacing in relation to the associated lateral surface of the tube portion 42. As a result, passage openings for the substance M to be dispensed are cut out.

The cutouts 43 are covered over by a flat part 44, forming the outlet valve A. The latter part is formed as a circular ring body and consists, for example, of the same material as the pumping chamber body 5, thus furthermore, for example, of a thermoplastic elastomer.

The flat part 44 is passed through centrally by the tube portion 42, or by the pressing-in formation 22, while the inner surface of the flat part 44 in the form of a circular ring and the lateral surface of the tube portion 42 interact in a sealing manner.

The flat part 44 rests on the upper side of the transitional wall 34 of the pumping chamber body 5. For this purpose, as mentioned, the upper side of the transitional wall 34, when considered radially from the inside, is initially level, that is to say is formed such that it is aligned in a plane transversely in relation to the dispenser axis x. The radial extent of this level supporting surface 45 in the form of a circular ring is chosen to be less than the radial extent of the flat part 44 between the inner edge of the ring and the outer edge of the ring.

The level supporting surface 45 merges radially outwardly into a slope, which ultimately ends in the thrust collar 35.

In the apex region between the level supporting surface 45 and the following slope, a rib 46 aligned concentrically with respect to the axis x is provided on the supporting surface. A free end region of the flat part 44 in the form of a circular ring rests on this rib 46.

On the upper side, the flat part 44 is pressed against the supporting surface 45 by supporting portions 47. These supporting formations are shaped in the manner of ribs, formed such that they run in the same direction as the dispenser axis on the outer lateral surface of the tube portion 42. In the exemplary embodiment represented, eight such supporting formations 47 are provided, uniformly distributed over the circumference of the tube portion 42. These formations extend in the vertical direction from the area of action of the flat part 44 to the underside of the actuating area 21.

The supporting formations 47 have a radial extent, when considered from the lateral surface of the tube portion 42, which corresponds to that of the cutouts 43 in the region of the ring portion 41. As a result, the flat part 44 is initially pressed by the supporting formations 47 against the ring portions that remain between the cutouts 43 in the circumferential direction and interact with the lateral wall of the tube portion 42. The radially outer support on the rib 46 produces a prestressing of the flat part 44 of the form represented in FIGS. 10 and 12, which enhances the sealing in the region of the outlet valve A created in this way.

The positive pressure built up in the pumping chamber 27 as a result of a vertical downward displacement of the head piece has the effect that the substance M that is present in the pumping chamber 27 and the dispensing chamber 23 is forced out by way of the dispensing channel 24, with partial vertical displacement of the flat part 44, forming the outlet valve A, in the region of the supporting surface 45 and in the region of the rib 46. Accordingly, the substance M passes through the cutouts 43 between the tube portion 42 and the pumping chamber body 5 or the ring portion 41 under the flat part 44, radially outward into the dispensing chamber 23.

After letting go of the head piece 3, and accordingly no longer applying pressure, the flat part 44 returns of its own volition into the sealing position according to FIGS. 10 and 11. The sealing effect is enhanced by the suction within the pumping chamber that is obtained in the course of the return.

The further embodiment shown in FIGS. 14 to 17 substantially corresponds to the third embodiment according to the representations in FIGS. 8 to 13, with the exception of the configuration of the inlet valve E.

The inlet valve E is formed here by a flat body 48, furthermore in the form of a valve disk 49. This is formed from the same material and in one piece with the pumping chamber body 5, extends furthermore in a transversely directed manner in relation to the dispenser axis x within the pumping chamber body 5. The valve disk 49 is positioned on the pumping chamber body 5 such that it is associated with the area of action 21, accordingly forming together with the latter a common plane that is facing the pressing-in formation 22.

The valve disk 49 is centrally provided with a circular opening 50. This opening has a diameter which corresponds approximately to half the inner diameter of the pressing-in formation 22.

The valve seat is formed by the central tube portion 14 of the chamber closure part 9. From the cylindrical tube portion 14, which engages in the base securing portion 29 of the pumping chamber body 5, there extends a conical roof portion 51, which is directed toward the valve disk 49. In the valve closure position, the vertex of the cone protrudes into the opening 50 in the valve disk 49.

In the valve closure position, the circumferential rim of the opening 50 rests in a sealing manner on the conical surface of the roof portion 51.

Radially outside the central zone of the roof portion 51, forming the valve seat, said roof portion is provided with passage openings 52. These are covered over in the valve closure position by the closed, annular portion of the valve disk 49.

The configuration of the valve disk 49 in one piece and from the same material as the pumping chamber body 5 means that the valve disk 49 has corresponding elastic properties. In the dispensing situation according to the representation in FIG. 15, the valve disk 49 is pressed with the rim of its opening against the conical roof portion 51. When the dispenser head piece 3 returns, and there is a corresponding suction effect, the valve disk 49 is lifted off from the valve seat according to the representation in FIG. 17, whereupon a substance flow path through the passage openings 52 of the roof portion 51 and through the opening 50 in the valve disk is obtained for refilling the pumping chamber body 5.

As this happens, the negative pressure acting on the valve disk 49 makes it pop out in the direction of the hollow space in the pumping chamber body.

FIGS. 18 to 20 show an embodiment which is likewise based on that according to the representations in FIGS. 8 to 13. This embodiment is a dispenser 1 for dispensing liquid substance M. The substance is kept in a container 6, which can be secured to the head piece 3 by way of a screw connection 53.

For this purpose, the chamber closure part 9 is provided with a corresponding internal thread 53. The head piece 3 of the dispenser 1 is enclosed by a wall portion 55 of the chamber closure part 9 that is aligned coaxially with the dispenser axis x, in such a way that displaceability of the head piece 3 in the axial direction can be achieved.

To suck in liquid substance M, the chamber closure part 9 has on the reservoir side a suction intake tube 56. In the exemplary embodiment represented, this tube is plug-mounted at one end in the central tube portion 14 of the chamber closure part 9 and extends to the base 7 of the, in this case piston-free, container 6, while ending at a distance from it.

The dispensing of substance, or emptying of the pumping chamber body 5, and re-filling of the pumping chamber body 5 take place in the same way as in the exemplary embodiments described above.

FIGS. 21 to 24 show a further embodiment of a dispenser 1 of the type in question. This is also substantially made up of a hollow-cylindrical substance reservoir 2 with a head piece 3, which is coupled to said reservoir and, in the not-in-use position represented in FIG. 21, is covered over by a cap 4.

The container base 7 is configured in the same way as that of the first exemplary embodiment. Furthermore, a feeding piston 8, by way of which the substance M to be dispensed is transported in the direction of the head piece 3, is positioned in the storage container 6. The feeding piston 8 is provided with a conically narrowing raised portion 28. This merges into a central flat region, which is aligned perpendicularly in relation to the dispenser axis x and in turn centrally carries a cylindrical protuberance 57, extending in the direction of the head piece 3. The surface of the feeding piston 8 facing the substance M is completely closed.

The container, which is initially upwardly open and consequently filled with substance M from above, is covered over by a chamber closure part 9. This part is initially configured in the manner of a cup, with an annular wall 10 lying against the container wall over part of its height on the inside and with a base 11 aligned initially substantially perpendicularly in relation to the dispenser axis x. Extending from this base 11, the chamber closure part 9 substantially follows the contour of the feeding piston 8, accordingly has a central raised portion 58, which merges into a central flat region aligned perpendicularly in relation to the dispenser axis x. This flat region carries a hollow-cylindrical tube portion 14 with an extent that is adapted to the vertical height of the protuberance 57 on the piston. At the end, that is to say facing away from the reservoir 2, the tube portion 14 forms a central passage opening 18.

Facing away from the reservoir 2, the chamber closure part 9 carries ribs 59 that are formed on in one piece. In this respect, a number of ribs 59 are provided, disposed uniformly over the circumference of the chamber closure part 9, thus furthermore twelve such ribs 59 in the exemplary embodiment represented. The radially outwardly facing end faces of the ribs 59 run parallel to and at a radial spacing from the annular wall 10 of the chamber closure part 9; by being disposed in this way, a circumferential annular gap 60 is obtained between the ribs 59 and the annular wall 10. The end region at the foot of the head piece wall 20 enters this gap, whereby said wall is guided radially outwardly by the annular wall 10 and radially inwardly by the ribs 59.

In the exemplary embodiment represented, the outer diameter of the tube portion 14 corresponds approximately to the vertical distance between the underside of the base 11, facing the reservoir 2, and the portion of the chamber closure part 9 that comprises a flat part carrying the tube portion 14.

The head piece 3 is formed substantially in the manner of an inverted cup, that is to say with the cup opening facing downward in the direction of the chamber closure part 9. The head piece wall 20, which in the same way as the container 6 is formed rotationally symmetrically with respect to the axis x, engages in the annular gap 60, guidance of the head piece 3 being achieved during a vertical displacement along the axis x.

The top of the head piece 3, which in cross-section runs at an acute angle in relation to a perpendicular to the axis x, forms an actuating area 21 on the upper side.

On the inner side of the cup of the head piece 3, that is to say on the underside of the actuating area 21, facing away from the top of the head piece in the direction of the chamber closure part 9, a tubular securing formation 61 is formed from the same material and in one piece with the head piece 3. This formation has an inner diameter which corresponds substantially to the outer diameter of the tube portion 14 of the chamber closure part. The head piece wall 20 and the securing formation 61 are aligned concentrically with respect to the axis x, the axial length of the downwardly-formed securing formation 61, that is to say formed in the direction of the chamber closure part 9 or of the centrally formed tube portion 14 thereof, corresponding approximately to 0.8 to 1.0 times the outer diameter of this formation.

The free end of the securing formation 61 is radially narrowed circumferentially on the outer wall, in which radially narrowed region a circumferential locking formation 62 is formed.

Extending from the root region on the underside of the top of the head piece, the securing formation 61 passes through a concentrically disposed dispensing chamber 23. This chamber merges into a dispensing channel 24 extending substantially radially outward in relation thereto. This channel extends obliquely upward from the dispensing chamber 23, adapted to the slope of the actuating area 21 with reference to the illustrations, to form a dispensing opening 25 at the end.

The dispensing chamber 23 and the reservoir 2 are coupled by way of a pumping chamber 27. This is formed by a pumping chamber body 5 of spring-elastic plastics material.

In a way corresponding to the exemplary embodiments described above, the pumping chamber body 5 firstly has in the bottom region a base securing portion 29, formed as an annular collar, which is formed in the manner of a sleeve, rotationally symmetrically with respect to the axis x. The base securing portion 29 encloses the tube portion 14 at the inner wall in a clamping manner, while furthermore the annular rim, facing downward in the direction of the chamber closure part, rests on the plane of the raised portion 53 that follows on radially outward from the tube portion 14. The resultant placement plane, aligned perpendicularly in relation to the dispenser axis x, is provided with the reference sign S.

From the placement plane S, the base securing portion 29 extends vertically upward, beyond the tube portion 14 in the direction of the head piece 3, the amount by which it extends vertically beyond the plane of the passage opening 18 of the tube portion 14 corresponding approximately to one third of the entire amount by which the base securing portion 29 extends vertically.

At the region of the base securing portion 29 extending vertically beyond the tube portion 14, an inlet valve E is attached on the inner side of the wall by way of three resilient webs 63 disposed such that they are uniformly distributed over the circumference. This valve is formed as a flat part 64, with a downward formation that plug-like or cone-like in cross-section and is associated with the passage opening 18. The webs 63, rooted at one end on the inner wall side at the pumping chamber wall 30, extend in the form of segments of a circular ring and at the other end carry the flat part 64, whereby the flat part 64 is provided with freedom of vertical movement with respect to the base securing portion 29.

The diameter and the plug-like cross-sectional configuration of the flat part 64 are adapted to the contour and the diameter of the passage opening 18, whereby the wall of the passage opening 18 that correspondingly widens conically in the vertically upward direction forms a sealing seat for the flat part 64 (cf. FIG. 25).

The portion of the base securing portion 29 that extends further above the attachment of the inlet valve E narrows in diameter with respect to the bottom portion of the base securing portion 29 that is associated with the placement plane S. This is achieved by a conical narrowing of the upper region of the base securing portion 29. The inner diameter d′ in the narrowed region of the base securing portion 29 corresponds approximately to 0.85 times the inner diameter d of the base securing portion 29 in the region that comprises the tube portion 14 and is seated on the placement plane S.

Following the attachment of the inlet valve E, furthermore following the conical narrowing of the base securing portion 29, the pumping chamber wall 30 widens conically, doing so furthermore in two stages. Starting from an un-pressed position according to FIG. 21, the pumping chamber wall 30 initially widens radially outward from the narrowed region conically at an angle of approximately 30° to a perpendicular plane in relation to the dispenser axis x, to an outer diameter which corresponds approximately to 2 times the inner diameter d in the area of placement. Forming an angle of approximately 90°, from here a pumping chamber wall portion extends with a radially inward tendency, from which a further stage radially widens conically to an outer diameter which corresponds approximately to 2.5 times the inner diameter d in the area of placement.

At the end, that is to say facing away from the base securing portion 29, the pumping chamber wall 30 carries an approximately horizontally running transitional wall 34, which is made of the same material and in one piece and at the end carries a thrust collar 35 aligned coaxially in relation to the axis x. This thrust collar 35 engages around the dispensing channel wall 36, in the form of a tube portion, of the dispensing chamber 23 in the region of a correspondingly shaped annular groove, the thrust collar 35 engaging in the annular groove in a clamping manner.

In the region of the level transitional wall 34, a rib 46 aligned concentrically in relation to the axis x is provided in the upward direction, that is to say facing the head piece 3. A free end region of the outlet valve A lies on this rib 46.

In the exemplary embodiment represented, this outlet valve A is configured as a valve body 65, preferably consisting of PE or TPE. The valve body 65 is secured on the head piece 3 which is in the form of an inverted hat, by engaging over the free, cross-sectionally narrowed end region of the securing formation 61, interaction with the locking formation 62 fixing the valve body 65 to the securing formation 61.

The valve body base 66 lies under the downwardly open securing formation 61, whereby the latter is closed with respect to the pumping chamber 27.

At the transitional stage of the securing formation 61 to the narrowed region of the same, the valve body 65 is supported by a peripheral collar 67 protruding radially outward from the cup wall. This collar 67 runs radially outward in the manner of a lip, for interaction with the rib 46 on the pumping chamber wall, in a way corresponding to a flat part 44. The outlet valve A is thereby formed.

The positive pressure built up in the pumping chamber 27 as a result of a vertical downward displacement of the head piece 3 has the effect that the substance M that is present in the pumping chamber 27 and the dispensing chamber 23 is forced out by way of the dispensing channel 24, with partial upward vertical displacement of the collar 67 of the valve body 65 forming the outlet valve A, with it lifting off from the rib 46. Accordingly, the substance M passes between the collar 27 and the transitional wall 34 of the pumping chamber wall 30 radially outward into the dispensing chamber 23.

In the pressed-down state of the pumping chamber wall 30 according to the representation in FIG. 22, a folding of the pumping chamber wall 30 builds up as a result of the configuration described above of the pumping chamber wall 30, which extends above the region of radial widening 68 following on from the base securing portion 29 and in vertical projection on this widening region 68, this widening region 68 running furthermore virtually horizontally in the pressed-down state, that is to say in a plane perpendicular to the dispenser axis x.

After letting go of the head piece 3, and accordingly no longer applying pressure, the collar 67 returns of its own accord into the sealing position as a result of the elastic properties. The sealing effect is enhanced by the suction within the pumping chamber 27 that is obtained in the course of the return.

In the course of the return of the head piece 3 and the accompanying negative pressure in the pumping chamber 27, the flat part 64 of the inlet valve E is raised in the vertical direction, to release the passage opening 18. Replenishing substance M is sucked into the pumping chamber 27 by way of the exposed passage opening 18.

FIGS. 26 to 30 show a further embodiment of the dispenser 1, which is based on the embodiment according to FIGS. 21 to 25.

In this further embodiment, to form the inlet valve E, the flat part 64, attached by way of the resilient webs 63, is formed in the downward direction in the manner of a spherical cap and accordingly also interacts in the manner of a plug with the passage opening 18. Contrary to the representations, the valve body may additionally also have a disk-shaped flat part 64, onto the underside of which the spherical cap form is injection-molded, this in the manner of an approximately hemispherical configuration. The embodiment represented is one in which the valve body is configured as half a hollow sphere to form the spherical cap shape, the attachment of the resilient webs 63 being effected on the outer side of the wall, associated with the rim of the half hollow sphere that opens upward toward the pumping chamber 27.

The inlet valve E in the form of a spherical cap interacts with a correspondingly configured sealing seat in the region of the passage opening 18. This seat is configured in the manner of a dish that opens upwardly toward the valve body, with a radius adapted to the outer radius of the spherical cap of the valve body. Accordingly, in the valve closure position, the spherically-shaped valve body is supported by a radially circumferential lateral wall portion on the half-shell-shaped valve seat that is passed through centrally by the passage opening 18.

As a result of the spherical cap-shaped configuration described above, reliable sealing is also achieved if there is an off-center misalignment of the flat part 64 or the valve body from the axial line.

In a further configuration, the dispensing chamber 23 surrounding the securing formation 61 is circumferentially limited to the region associated with the dispensing channel 24.

For this purpose, it is provided in a first embodiment according to the sectional representation in FIG. 28 that, in a plan view, the dispensing chamber 23 associated with the dispensing channel 24 extends over an angle of approximately 30° to 45°. When considered in the circumferential direction, the dispensing chamber 23 is bounded by rib-shaped supporting formations 47, which radially follow on from the securing formation 61. In the exemplary embodiment represented, the amount by which they radially extend corresponds to the amount by which the dispensing chamber 23 radially extends, as a result of which the supporting formations 47 provided to the sides of the dispensing chamber 23 facing the dispensing channel 24 represent lateral bounding walls for the dispensing chamber 23.

In the region facing circumferentially away from the dispensing chamber 23, further such radially widened supporting formations 47 are provided radially outside the securing formation 61. As a result of this disposition and the chosen radial extent of the supporting formations 47, the collar 67 of the valve body 65 is held captively in this region between the lower extreme edges of the supporting formations 47 and the peripheral sealing seat rib 46 of the pumping chamber body 5, and is correspondingly impeded with regard to displacement of the collar 67 into an open position of the valve by splaying.

Splaying of the collar portion into the open position of the valve can only be achieved in the region of the dispensing chamber 23, by omitting any supporting formations 47 or, as is alternatively possible, by providing radially shorter supporting formations 47 that allow the collar 67 to move.

As a result of the configuration described above, a minimization of the residual volume that cannot be dispensed by the pumping movement is achieved.

A further alternative solution for reducing the residual volume is shown by the sectional representation in FIG. 29. In this, the supporting formations 47 bounding the dispensing chamber 23 and urging the collar 67 into the valve closure position are replaced by an insert part 69. This insert part is shaped in the form of a portion of a circular ring, with an inner diameter adapted to the outer diameter of the securing formation 61. The outer diameter of the insert part 69 corresponds to the outer diameter of the dispensing chamber 23.

In plan view, the insert part 69 in the form of a portion of a circular ring opens over an angle of approximately 30° to 45°, to delimit the dispensing chamber 23 associated with the dispensing channel 24.

The insert part 69 is secured to the securing formation 61 in such a way as to prevent rotational displacement, in particular it is fixed against rotation.

Reducing the residual volume by delimiting the dispensing chamber 23 in the circumferential direction is also possible in conjunction with the embodiments represented in FIGS. 8 to 20 by supporting formations 47 being correspondingly configured or by an insert part 69 being provided.

All features disclosed are (in themselves) pertinent to the invention. The disclosure content of the associated/accompanying priority documents (copy of the prior patent application) is also hereby incorporated in full in the disclosure of the application, including for the purpose of incorporating features of these documents in claims of the present application.

### LIST OF REFERENCE SIGNS

1 Dispenser

2 Reservoir

3 Head piece

4 Covering cap

5 Pumping chamber body

6 Container

7 Container base

8 Feeding piston

9 Chamber closure part

10 Annular wall

11 Base

12 Grooves

13 Radial collar

14 Tube portion

15 Elevation

16 Cone portion

17 Cap portion

18 Passage openings

19 Annular collar

20 Head piece wall

21 Actuating area

22 Pressing-in formation

23 Dispensing chamber

24 Dispensing channel

25 Dispensing opening

26 Foam valve

27 Pumping chamber

28 Raised portion

29 Base securing portion

30 Pumping chamber wall

31 Area of action

32 Widening portion

33 Narrowing portion

34 Transitional wall

35 Thrust collar

36 Dispensing channel wall

37 Annular step

38 Lip

39 Lip

40 Locking means

41 Ring portion

42 Tube portion

43 Cutouts

44 Flat part

45 Supporting surface

46 Rib

47 Supporting formations

48 Flat body

49 Valve disk

50 Opening

51 Roof portion

52 Passage opening

53 Screw connection

54 Internal thread

55 Wall portion

56 Suction intake tube

57 Protuberance

58 Raised portion

59 Ribs

60 Annular gap

61 Securing formation

62 Locking formation

63 Webs

64 Flat part

65 Valve body

66 Valve body base

67 Collar

68 Widening region

69 Insert part

a Height

b Wall thickness

c Reduced wall thickness

d Diameter

d′ Diameter

l Length

p Width

r Direction of passing through

A Outlet valve

E Inlet valve

M Substance

S Placement plane

T Tangent

x Dispenser axis

α Angle

1-41. (canceled)

42. Dispenser (1) for dispensing liquid or pasty substances (M), with a substance reservoir (2), a head piece (3), a pumping chamber (27), and an outlet valve (A) and an inlet valve (E), the pumping chamber (27) being formed from a spring-elastic plastics material as a one-part pumping chamber body (5) and the pumping chamber body (5) having a base securing portion (29) formed as an annular collar, the outlet valve (A) and/or the inlet valve (E) furthermore comprising a part (44) which is separate from but interacts with the pumping chamber body (5) and rests on the pumping chamber body (5) with at least partial freedom of vertical movement, wherein at the free end facing away from the base securing portion (29), the pumping chamber wall (30) has a transitional wall (34), formed from the same material and in one piece and extending in a flared manner from the pumping chamber wall (30), which wall carries an annular thrust collar (35) at the end, wherein the outlet valve is formed by a flat part (44) and wherein the flat part (44) rests on the upper side of the transitional wall (34) of the pumping chamber body (5).

43. Dispenser according to claim 42, wherein the actuation of the valve is effected by at least partial vertical displacement of the flat part (44) that forms the outlet valve (A), in the region of the supporting surface of the transitional wall (34) of the pumping chamber body (5).

44. Dispenser according to claim 42, wherein a pressing-in formation (22) that is vertically associated with the base securing portion (29) and can be acted upon by way of the head piece (3) is provided.

45. Dispenser according to claim 42, wherein the inlet valve (E) comprises a flat body (48) which is connected to the pumping chamber body (5) and rests on a chamber closure part (9) on the reservoir side.

46. Dispenser according to claim 42, wherein the outlet valve (A) is formed as a collar (67) of a cross-sectionally hat-like valve body (65).

47. Dispenser according to claim 42, wherein a locking formation (62) protruding inward on the head piece (3) secures the outlet valve (A) in a locking manner.

48. Dispenser according to claim 42, wherein the vertical extent of the outlet valve (A) corresponds to the radius of the outlet valve (A) or more.

49. Dispenser according to claim 42, wherein the inlet valve (E) is a flat part (64) attached to an inner wall of the pumping chamber body (5) by way of resilient webs (63).

50. Dispenser according to claim 49, wherein the flat part (64) is shaped in cross-section in the manner of a plug.

51. Dispenser according to claim 49, wherein the flat part (64) is shaped in cross-section in the form of a cone.

52. Dispenser according to claim 49, wherein the flat part is shaped in cross-section in the form of a spherical cap.

53. Dispenser according to claim 49, wherein the flat part (64) interacts with a passage opening (18) formed in the chamber closure part (9).

54. Dispenser according to claim 42, wherein the inlet valve (E) is disposed offset with respect to the placement plane (S) of the base securing portion (29).

55. Dispenser according to claim 42, wherein the base securing portion (29) narrows in diameter above the attachment of the inlet valve (E).

56. Dispenser according to claim 42, wherein following the attachment of the inlet valve (E), the pumping chamber wall (30) widens conically, which widening region (68) runs horizontally in the pressed-down state.

57. Dispenser according to claim 56, wherein in the pressed-down state, a folding of the pumping chamber wall (30) builds up above the widening region (68) and in vertical projection on the widening region (68).

58. Dispenser according to claim 42, wherein an internal guidance for the head piece (3) is provided by ribs (59) aligned radially on the chamber closure part (9).

59. Dispenser according to claim 42, wherein the valve seat of the valve disk (49) is conically formed.

60. Dispenser according to claim 42, wherein the valve seat of the valve disk (49) is formed as a spherical cap.

61. Dispenser according to claim 44, wherein the pressing-in formation (22) interacts with the transitional region between the inlet valve (E) and the pumping chamber wall (30).

62. Dispenser according to claim 44, wherein the pressing-in formation (22) is formed from the same material as the head piece (3).

63. Dispenser according to claim 42, wherein a portion of the pumping chamber body (5) over an axial length (l) which corresponds to a multiple of its wall thickness (b, c) has a changing wall thickness (b, c).

64. Dispenser according to claim 63, wherein the pumping chamber body (5) has a smaller wall thickness (c) in a middle region than in at least one of the end regions.

65. Dispenser according to claim 42, wherein the pumping chamber body (5) has an axial length (l) which corresponds to 0.9 to 2 times the width (p), measured transversely thereto, of the pumping chamber body (5).

66. Dispenser according to claim 42, wherein the pumping chamber (27) has an inner contour which has a continuously widening portion and a continuously narrowing portion, the portions converging and diverging in the course of a pumping operation.

67. Dispenser according to claim 42, wherein the inlet valve (E) comprises a valve disk (49) with a central opening (50).

68. Dispenser according to claim 67, wherein the chamber closure part (9) is closed where it is associated with the central opening (50), but radially outside this has a passage opening (52).

69. Dispenser according to claim 45, wherein the chamber closure part (9) continues on the reservoir side into a suction intake tube (56).

70. Dispenser according to claim 42, wherein the flat part (44) lies on the inner side against a tube portion (42) connected to the head piece (3).

71. Dispenser according to claim 42, wherein where it is associated with the flat part (44), the pumping chamber body (5) is spaced apart from the tube portion (42), at least in certain regions.

72. Dispenser according to claim 70, wherein the tube portion (42) has supporting formations (47), which rest on the flat part (44) from above.

73. Dispenser according to claim 72, wherein in the over-engaging region, the supporting formations (47) are radially smaller than the flat part (44).

74. Dispenser according to claim 72, wherein the supporting formations (47) are radially smaller than the flat part (44) in an over-engaging region associated with a dispensing channel (24) and radially the same as or larger than the flat part (44) in a circumferentially following over-engaging region.

75. Dispenser according to claim 72, wherein the supporting formations (47) are formed by vertically aligned ribs which protrude radially from the tube portion.

76. Dispenser according to claim 72, wherein the supporting formations (47) are formed by a separate insert part (69), which insert part (69) engages radially around the tube portion.

77. Dispenser according to claim 42, wherein the flat part (44) is formed as a circular ring body.

78. Dispenser according to claim 42, wherein the flat part (44) is disposed within an outer, vertically extending dispensing channel wall (36).

79. Dispenser according to claim 42, the pumping chamber body (5) being formed in an elliptical shape in longitudinal cross-section, with a thrust collar (35) protruding outward therefrom, but rooted in the pumping chamber wall (30), wherein the thrust collar (35) follows on from the pumping chamber wall (30) by way of a transitional wall (34) forming an angle (α) of 45° to 135° with a local tangent (T) to the pumping chamber wall (30).

80. Dispenser according to claim 42, wherein in a vertical projection, the thrust collar (35) lies outside the pumping chamber wall (30).
